(19) United States
(12) Patent Application Publication
(10) Pub. No.: US 2011/0295618 A1
(43) Pub. Date: Dec. 1, 2011

(54) Apparatus and method for generating quality informatics knowledge

(76) Inventors: Amrita D. Naipaul, Hyattsville, MD (US); Brian R. Jacobs, Annapolis, MD (US)

(21) Appl. No.: 13/067,106

(22) Filed: May 9, 2011

Related U.S. Application Data
(60) Provisional application No. 61/332,514, filed on May 7, 2010.

(51) Int. Cl. G06Q 50/00; G06Q 10/00

(52) U.S. Cl. 705/3; 705/2

(57) ABSTRACT

An apparatus and method for generating quality informatics knowledge. The apparatus and method include developing a policy and/or procedure developed for a quality improvement program; defining set of data to be used in implementing the policy and/or procedure developed for the quality improvement program; modifying and/or creating electronic documents on an EHR system and/or fields in the electronic documents on the EHR system for a healthcare provider to input at least a portion of the defined data set, wherein the EHR system including an EHR database configured to store the clinical data and a clinician workstation configured to receive the clinical data as input from a healthcare provider; entering clinical data into the EHR system via the clinician workstation, the clinical data including the defined data set; storing the clinical data on the EHR database; scheduling a time to extract the defined set of data from the clinical data on the EHR database; extracting the defined set of data from the clinical data on the EHR database; manipulating the defined set of data with a graphical database tool; generating electronic reports with the graphical database tool using the defined set of data; disseminating the reports to different healthcare providers; receiving feedback from the healthcare providers on the policy and/or procedure for the quality improvement program; modifying the policy and/or procedure for the quality improvement program based on the feedback received from the healthcare providers; and repeating the preceding steps until the defined set of data identifies progress toward one or more goals of the quality improvement program.

### CROSS-REFERENCE TO RELATED APPLICATIONS

The present application claims the benefit of U.S. Provisional Application No. 61/332,514, filed May 7, 2010, the entire contents of which are hereby incorporated by reference as if fully set forth herein.

### FIELD OF THE INVENTION

The present invention relates to clinical evaluations and management. More particularly, the present invention relates to the creation of data in Electronic Health Records (EHRs), the extraction and aggregation of that data, and the manipulation of that data into meaningful measurements of efficiency, effectiveness, quality, safety, and compliance in a healthcare setting.

### Computer Program Listing

A Computer Program Listing Appendix has been submitted on two, identical compact discs in computer readable form, labeled “Copy 1” and “Copy 2”, which is a duplicate of “Copy 1”. The Computer Program Listing Appendix includes the following files:

Files Contained On Computer Program Listing Appendix

| File | | | |
|---|---|---|---|
| No. | File Name | File Size (Bytes) | Date Created |
| 1 | EHR_Request_Code.rtf | 40,960 | May. 08, 2011 |
| 2 | Data_Manipulation_Code.rtf | 45,05 | May. 08, 2011 |
| 3 | Data_Filter_Code.rtf | 36,864 | May. 08, 2011 |

The material contained in the Computer Program Listing Appendix is herein incorporated by reference.

### BACKGROUND OF THE INVENTION

Historically, quality improvement (QI) methods in healthcare have originated from both business processes and medicine. A hallmark of QI is the concept of a system or network that involves the interaction and dependency between people, processes, and items that work together toward a common goal. That method of QI relies on measurement and feedback processes that require identification of measures, data collection, and feedback to guide QI programs.

In their current state, QI methods in healthcare are primarily derived from the concepts of Walter Shewhart, who published principles and techniques related to data measurement, statistical control, and the visual display of data. Shewhart described manufacturing processes under statistical control as a three step process of specification, production, and inspection. He specifically related that process to the scientific method of hypothesis, experiment, and evaluation. Shewhart intended that process to be used by statisticians to help change the demand for goods by using it to determine how to close up tolerance ranges and to improve the quality of goods. In other words, Shewhart intended the statisticians to take action based on the conclusions of the evaluation. That process became known as the Plan-Do-Check-Act (PDSA) process.

W. Edwards Deming applied Shewhart's concepts and created the Plan-Do-Study-Act (PDSA) process as a QI methodology. A fundamental principle of that methodology is iteration—once a plan is implemented and confirmed (or negated) and the appropriate action is taken, performing the process again will extend the knowledge gained from it even further. In that way, the PDSA process can be repeated in a cyclical, iterative manner to achieve results closer to the desired goal with each iteration.

Although the PDSA process is generally used as a business model, it has recently been popularized in healthcare as a model for QI. In the healthcare setting, however, a significant burden exists for implementing that process due to the resources required for data collection, analysis, interpretation, and display. Data collection is a labor intensive process that often requires manual review of paper-based patients charts. That timely process also limits the quantity of data that can be collected. For example, only one in fifteen clinical documents is typically sampled during such processes, which often results in sampling bias. In addition, traditional paper-based QI feedback processes can be delayed due to the time required to analyze that data, thereby creating a lag between the discovery of information, the identification of improvements and/or setbacks, and the opportunity to respond to those discoveries and/or identifications. Such delays are detrimental to the cyclical, iterative nature of the PDSA process by interfering with the continuous and purposefully timely feedback needed to make such a process effective.

Paper-based clinical records are also problematic because such static and individualized documentation often lack legibility, accessibility, and workflow-integrated decision support. Moreover, comprehensive data aggregation and analysis is often difficult with paper-based documentation. Thus, paper-based PDSA processes only allow for a limited amount of manual chart auditing in addition to delaying provider feedback. While certain delays in comprehending process efficiency in manufacturing or other industries may be acceptable, such delays in understanding the quality, efficiency, effectiveness, safety, and compliance of healthcare delivery are unacceptable. As a result, there is a need in the art for an apparatus and method for collecting, extracting, and aggregating clinical data in real time and for manipulating that data into meaningful measurements of efficiency, effectiveness, quality, safety, and compliance in a healthcare setting.

That need is more clearly illustrated by way of specific example—pain assessment and management. In this case, pain assessment and management is appropriate not just because of the magnitude of the problem and recent regulatory requirements to address it, but additionally the desire to make timely and impactful changes in patient care and outcomes. It is estimated that, in the United States, more than 76 million people suffer from pain. In 2001, pain management standards went into effect for Joint Commission accredited ambulatory care facilities, behavioral health care organizations, critical access hospitals, home care providers, hospitals, office-based surgery practices, and long term care providers. Those pain management standards addressed the assessment and management of pain and require organizations to: (1) recognize the right of patients to appropriate assessment and management of pain, (2) screen patients for pain during their initial assessment and, when clinically required, during ongoing, periodic re-assessments, and (3) educate patients suffering from pain and their families about pain management.

Optimal pain management requires compliance with objective assessments, treatments, monitoring, and documentation. Optimal documentation of pain assessment, reassessment and effective management is challenging for many organizations. A recently published study on improving the assessment and management of pain reported that reassessments were completed within one hour of a pain intervention only 24% of the time. And although that percentage was increased to 94.9% utilizing a PDSA process, it was noted that the paper documentation system was limited in providing timely feedback to evaluate practice changes. Thus, even though a PDSA process produced notable improvements in a paper-based system, the timeliness of feedback in that system was identified as a limiting factor.

In addition to the limitations of paper-based systems, previous studies on the assessment and management of pain have been limited in number and characterized by broad age ranges and small sample sizes, thereby limiting their accuracy. Studies of clinical efficiency, clinical effectiveness, patient satisfaction, evidence-based medicine, quality care delivery, and safe care delivery have encountered similar limitations. Accordingly, there is a more specific need in the art for an apparatus and method for collecting, extracting, and aggregating clinical data in real time and for manipulating that data into meaningful measurements of pain assessment and management, clinical efficiency, clinical effectiveness, patient satisfaction, evidence-based medicine, quality care delivery, and safe care delivery.

### SUMMARY OF THE INVENTION

To address at least the problems and/or disadvantages described above, it is a non-limiting object of the present invention to provide an apparatus and method for generating quality informatics knowledge. The apparatus and method include developing a policy and/or procedure developed for a quality improvement program; defining set of data to be used in implementing the policy and/or procedure developed for the quality improvement program; modifying and/or creating electronic documents on an EHR system and/or fields in the electronic documents on the EHR system for a healthcare provider to input at least a portion of the defined data set, wherein the EHR system including an EHR database configured to store the clinical data and a clinician workstation configured to receive the clinical data as input from a healthcare provider; entering clinical data into the EHR system via the clinician workstation, the clinical data including the defined data set; storing the clinical data on the EHR database; scheduling a time to extract the defined set of data from the clinical data on the EHR database; extracting the defined set of data from the clinical data on the EHR database; manipulating the defined set of data with a graphical database tool; generating electronic reports with the graphical database tool using the defined set of data; disseminating the reports to different healthcare providers; receiving feedback from the healthcare providers on the policy and/or procedure for the quality improvement program; modifying the policy and/or procedure for the quality improvement program based on the feedback received from the healthcare providers; and repeating the preceding steps until the defined set of data identifies progress toward one or more goals of the quality improvement program. Those and other objects, advantages, and features of the present invention will become more readily apparent by the following written description, taken in conjunction with the accompanying drawings and claims.

### BRIEF DESCRIPTION OF THE DRAWINGS

Aspects of the present invention can be better understood with reference to the following drawings, which are part of the specification and represent preferred embodiments of the present invention. The components in the drawings are not necessarily to scale, emphasis instead being placed upon illustrating the principles of the present invention.

FIG. 1 is a chart illustrating the general steps of a PDSA process;

FIG. 2 is a schematic view illustrating an exemplary Quality Informatics Knowledge (QIK) network according to a non-limiting embodiment of the present invention;

FIG. 3 is a flow chart illustrating an exemplary QIK process according to a non-limiting embodiment of the present invention;

FIG. 4 is a chart illustrating an exemplary policy and procedure for a Quality Improvement program according to a non-limiting embodiment of the present invention;

FIG. 5 is a chart illustrating an exemplary PDSA process according to a non-limiting embodiment of the present invention;

FIG. 6 is a screen capture illustrating exemplary EHR documentation according to a non-limiting embodiment of the present invention;

FIGS. 7A-7C are screen captures illustrating exemplary pain assessment documentation according to non-limiting embodiments of the present invention;

FIGS. 8A-8G are diagrams illustrating exemplary pain assessment tools that are used according to a non-limiting embodiment of the present invention;

FIG. 9 is a screen capture illustrating exemplary functionality of a graphical database tool according to a non-limiting embodiment of the present invention;

FIGS. 10A and 10B are charts illustrating exemplary assessment reports according to non-limiting embodiments of the present invention;

FIGS. 11A-11C are a graphs illustrating exemplary progress reports according to non-limiting embodiments of the present invention;

FIG. 12 is a graph illustrating an exemplary comparative report according to a non-limiting embodiment of the present invention;

FIG. 13 is a chart illustrating an exemplary color-coded table report according to a non-limiting embodiment of the present invention;

FIG. 14 is a chart illustrating an exemplary Adverse Event (AE) list according to a non-limiting embodiment of the present invention;

FIG. 15 is a chart illustrating an exemplary AE report according to a non-limiting embodiment of the present invention;

FIGS. 16A-16E are graphs illustrating exemplary transfer reports according to non-limiting embodiments of the present invention;

FIGS. 17A and 17B are a charts illustrating an exemplary ulcer assessment documentation according to a non-limiting embodiment of the present invention;

FIG. 18 is a chart illustrating an exemplary pressure ulcer scale according to a non-limiting embodiment of the present invention;

FIG. 19 is a chart illustrating an exemplary satisfaction report according to a non-limiting embodiment of the present invention;

FIG. 20 is a chart illustrating exemplary results achieved via implementation of the present invention.

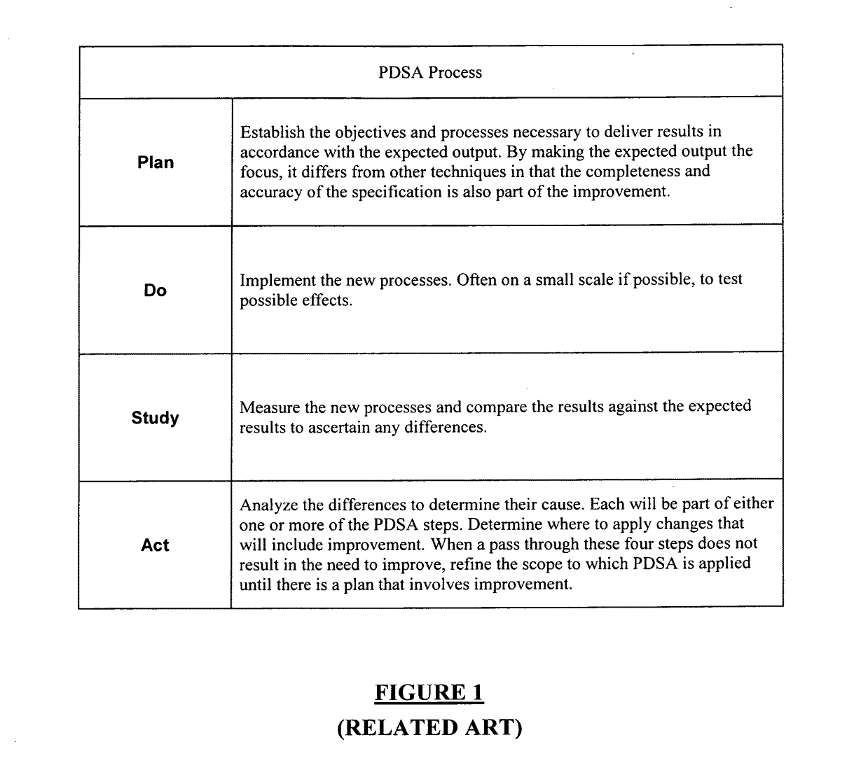

Attention is also called to the Computer Program Listing Appendix that is incorporated by reference.

### DETAILED DESCRIPTION OF THE PREFERRED EMBODIMENTS

The present invention overcomes the shortcomings of the prior art and provides at least the advantages discussed below by (1) creating custom data fields in an Electronic Health Record (EHR) that have particular utility in conducting QI analyses, (2) using front-end software to extract the clinical data collected with the EHR in real time, and (3) conducting logical queries of the extracted data to manipulate that data into meaningful measurements of pain assessment and management, clinical efficiency, clinical effectiveness, patient satisfaction, evidence-based medicine, quality care delivery, and safe care delivery. The front-end software of the present invention is configured to be used with substantially any EHR system (e.g., EHR systems provided by Meditech, Cerner, McKesson, Epic Systems, Siemens Healthcare, Computer Programs, Systems, Inc., Healthcare Management Systems, Healthland, Eclipses (now Allscripts), etc.) such that clinical data can be isolated and extracted from substantially any EHR system at substantially any healthcare provider location. The front-end software of the present invention is also configured to manipulate that data into meaningful measurements of pain assessment and management, clinical efficiency, clinical effectiveness, patient satisfaction, evidence-based medicine, quality care delivery, and safe care delivery by aggregating it, performing various calculations with/on it, and presenting the results to a user in a meaningful way. And by integrating the front-end software of the present invention with one or more EHR systems, the front-end software of the present invention can perform that data extraction and manipulation in real time as the subject data is gathered with those EHR systems. Accordingly, the front-end software of the present invention can provide near-instantaneous feedback for a variety of user-defined queries, making it particularly suited for implementing QI-type PDSA processes.

As discussed above, the shortcomings of conventional QI-type PDSA processes are associated with ineffective oral and written communication and poor clinician documentation. EHR systems provide an important tool to aid in solving many of the problems associated with inadequate clinician documentation. EHR systems are intuitive electronic documentation platforms that provide improved legibility, completeness, and accessibility in clinical documentation. EHR systems can also provide clinical decision support (CDS) to practitioners, such as documentation prompts and evidence-based guidelines integrated into the provider's workflow, to further improve the accuracy and completeness of clinical documentation. By providing a platform for discrete data entry directly by clinicians, EHR systems provide a rich substrate for real-time quality- and research-based data mining. Moreover, they allow data to be mined across large sample sizes without additional labor. Those qualities make EHR systems particularly suited for use with the front-end software of the present invention.

With the continued inadequate adoption of best practices and the rising costs of healthcare, there are clear opportunities for improving quality and effectiveness in the healthcare industry. And as healthcare organizations adopt and implement EHRs into the healthcare setting, QI methodologies must advance to capture the wealth of data that are already embedded within or that can be customized and added into the EHR system. The front-end software of the present invention capitalizes on those opportunities and provides a novel advancement in QI methodologies. Moreover, it provides incentive form healthcare providers to implement EHR systems as QI standards become more central to hospital accreditation, specialized practice recognition and certification, and optimized patient outcomes.

Those and other advantages provided by the present invention can be better understood from the description of the preferred embodiments below and in the accompanying drawings. In describing the preferred embodiments, specific terminology is resorted to for the sake of clarity. However, the present invention is not intended to be limited to the specific terminology so selected, and it is to be understood that each specific term includes all technical equivalents that operate in a similar manner to accomplish a similar purpose. For example, although the term “EHR” is generally used to refer to an electronic clinical documentation system, other types electronic clinical documentation systems may also be used (e.g., Electronic Medical Records (EMRs)).

### A. QIK Network

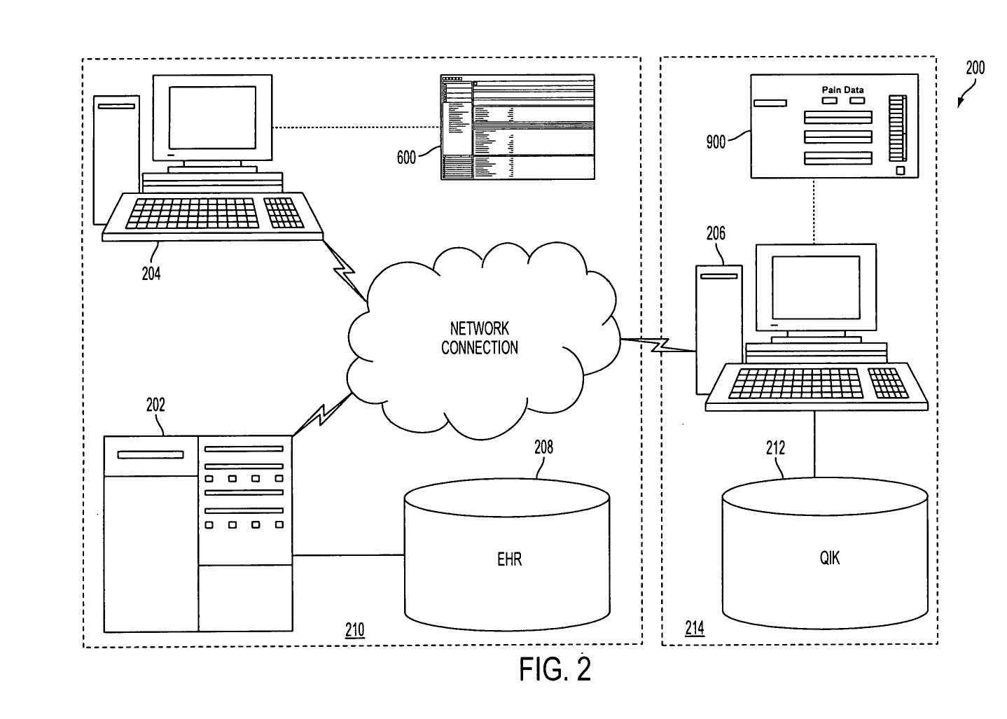

Turning to the drawings, FIG. 2 is a schematic diagram illustrating the basic components of a network 200 for developing quality informatics knowledge (QIK). The QIK network 200 includes at least one central services server 202, at least one clinician workstation 204, and at least one QIK workstation 206. The central services server 202, clinician workstation 204, and QIK workstation 206 are in electronic data communication with each other via a network connection so as to form a local area network (LAN) and/or a wide area network (WAN). Those connections can be wired and/or wireless.

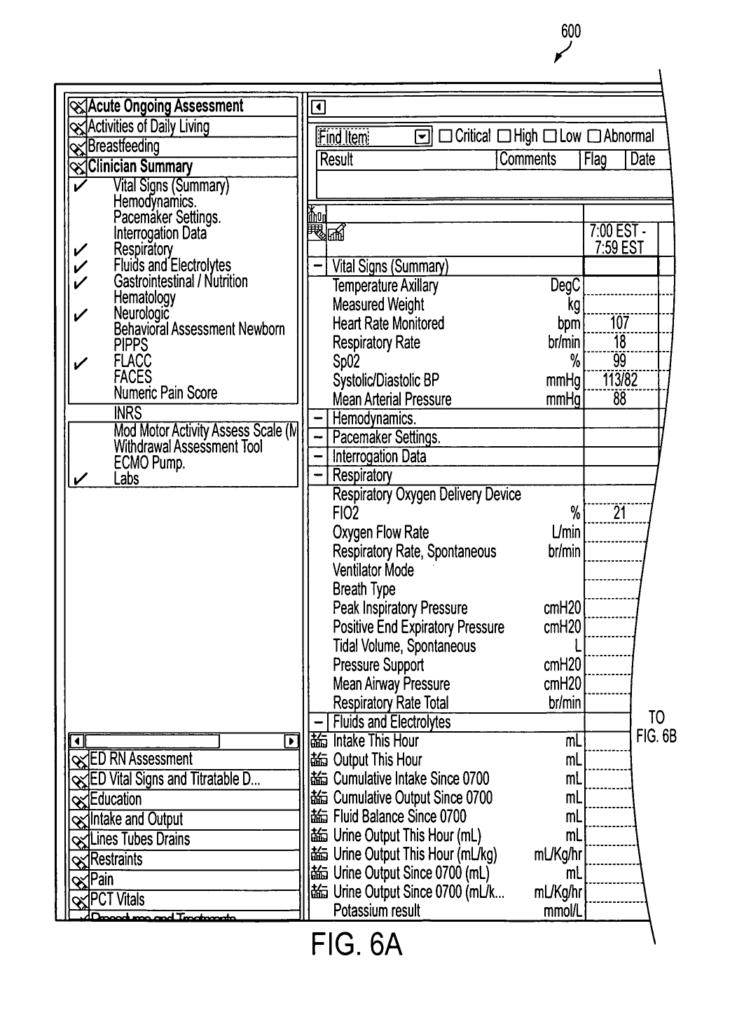

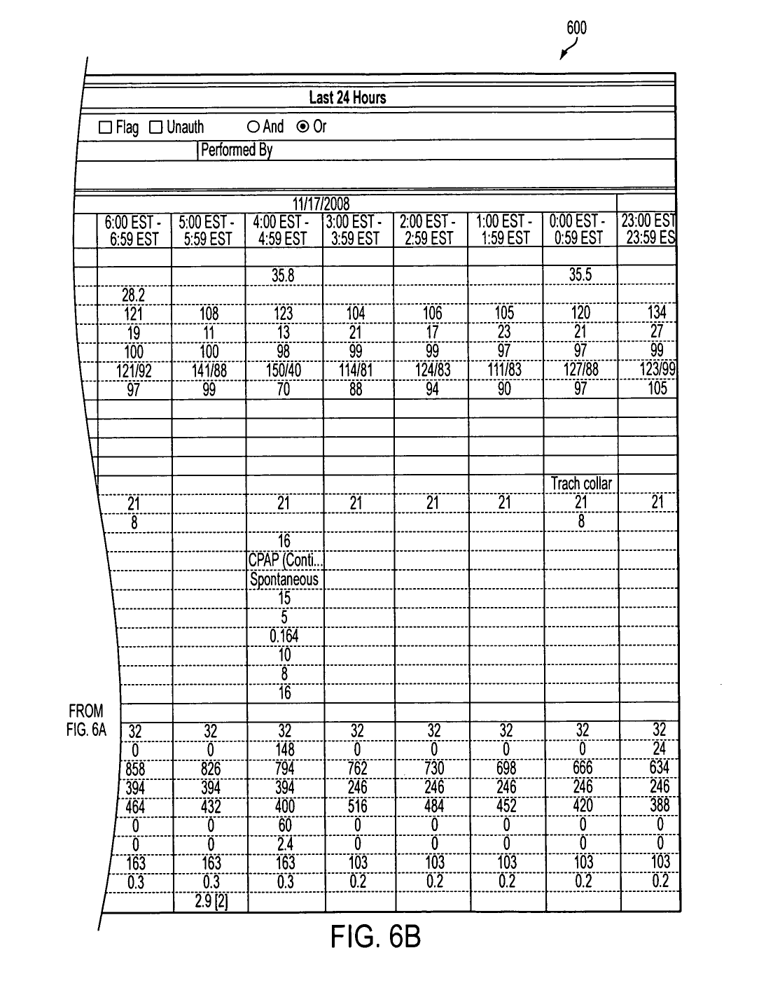

The central services server 202 and the clinician workstation 204 each include a processor that executes instructions embodied on a computer-readable media to support the functionality of an EHR system. The clinician workstation 204 includes clinical documentation functionality that includes existing EHR documentation 600 (FIG. 6) that is configured to be used by a healthcare provider to capture clinical data in real time at the point of care. And the central services server 202 is configured to collect the data captured with the clinician workstation 204 and to store it on the EHR database 208 in accordance with a relational database management system (RDBMS). The central services server 202 is preferably in electronic data communication with a plurality of clinician workstations 204 at a healthcare provider location so that multiple patients and healthcare providers can be monitored simultaneously at multiple points of care. And each of the plurality of clinician workstations 204 may also store that data locally on an appropriate storage device (e.g., hard disk drive, optical disk, flash memory, etc.). Together, the central services server 202, the clinician workstation 204, and the EHR database 208 form an EHR system 210.

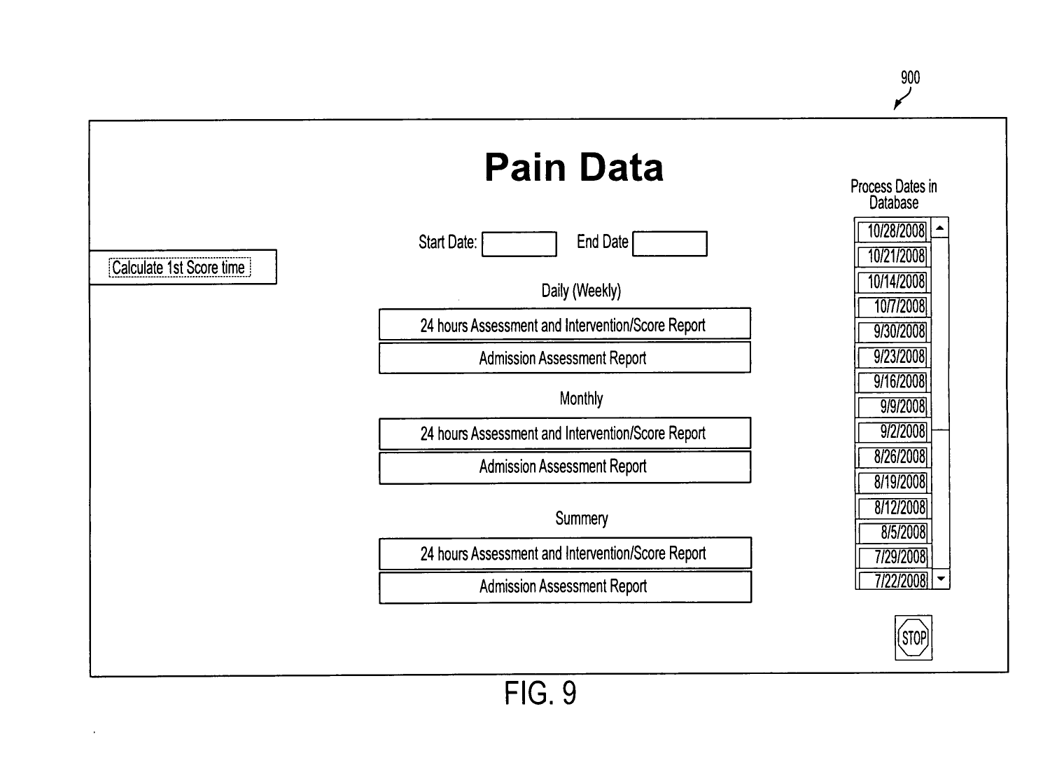

The QIK workstation 206 includes a processor that executes instructions embodied on a computer-readable media to support the QIK functionality of the present invention. That QIK functionality includes a graphical database tool 900 (FIG. 9) that is configured to be used by a healthcare provider to extract and manipulate the data captured with the central services servers 204 in real time as that data is captured. The QIK functionality is also configured to store that data on a QIK database 212 in accordance with a RDBMS. Together, the QIK workstation 206 and QIK database 212 form a QIK system 214.

Although illustrated as separate databases in FIG. 2, the EHR database 206 and QIK database 212 may also be provided as a single database. And although the clinician workstation 204 and QIK workstation 204 are illustrated as separate workstations in FIG. 2, they may also be provided as a single workstation. Moreover, the functionality described as being provided by the central services 202, the clinician workstation 204, and the QIK workstation 206 may be accessed through the central services server 202 using any suitable computing device (e.g., desktop computer, laptop computer, tablet computer, personal digital assistant (PDA), smart phone, etc.), such as via cloud computing.

To receive input from healthcare providers, the clinician workstation 202 and the QIK workstation 204 each include one or more input devices (e.g., keyboard, mouse, touchscreen, clinical instruments, etc.). And to represent the data captured and/or manipulated with the clinician workstation 202 and the QIK workstation 204, they also each include a graphical display (e.g., a computer monitor, a digital readout (DRO), etc.). As such, the clinician workstation 202 and the QIK workstation 204 each provide a healthcare provider with a graphical user interface for interacting with, supporting, and utilizing the functionality of the present invention. The clinician workstation 202 and the QIK workstation 204 may be provided as any suitable computing device that includes those features (e.g., desktop computer, laptop computer, tablet computer, personal digital assistant (PDA), smart phone, etc.).

The functionality provided by the central services 202, the clinician workstation 204, and the QIK workstation 206 is implemented using a three-tiered architecture. More specifically, the input and display of data is performed in the presentation tier; the various actions performed on that data is performed in the business logic tier; and the storage of that data with a DBMS is performed in the data tier. That configuration improves the scalability of the QIK network 200 and allows the data to easily be shared among the various components of the QIK network 200. It also allows a large number of clinician workstations 204 to be seamlessly integrated into the QIK network 200 so as to increase the sample size of patients and healthcare providers for which QI-related activities can be monitored and evaluated. Moreover, it allows the front-end software of the present invention to be installed on the QIK workstation 206 such that the QIK workstation 206 can extract the clinical data collected and stored by the central services 202 and the plurality of clinician workstations 204 in real time as that data is collected.

### B. QIK Process

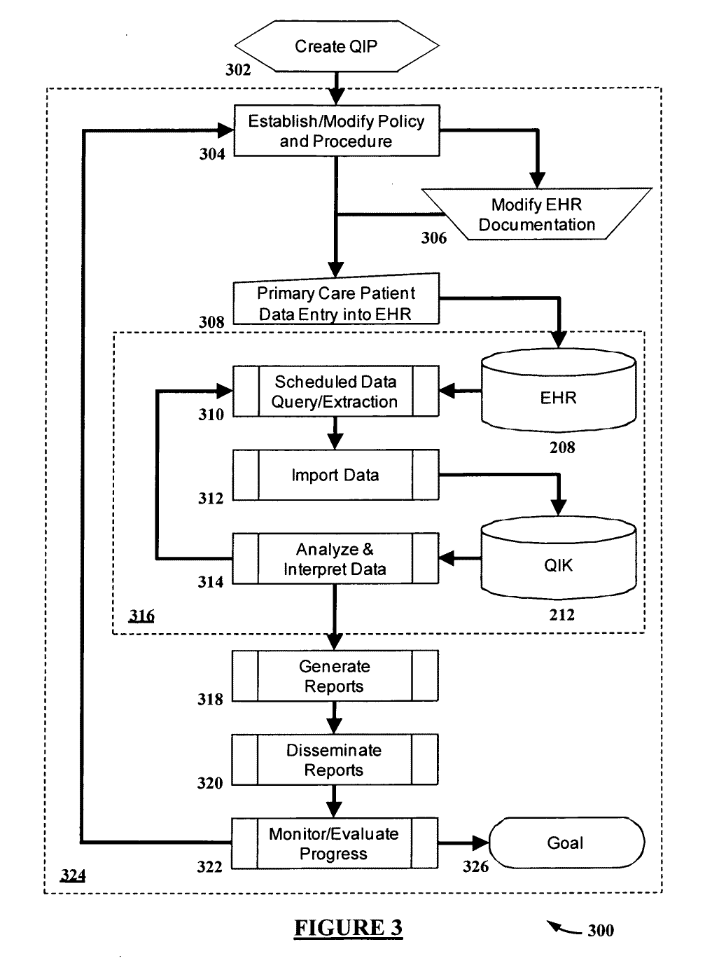

As FIG. 3 illustrates, those QI-related activities are monitored and evaluated with the present invention in a cyclical, iterative QI process 300 for developing Quality Informatics Knowledge (QIK) based on a PDSA framework. At step 302 of that QIK process 300, healthcare providers create QI programs that they would like implement to satisfy specific goals. Those goals may be patient-specific goals, location-specific goals, or enterprise/facility goals. For example, to satisfy the location-specific goal of improving pain management at a specific healthcare facility (e.g., hospital, extended-care facility, etc.), a QI program could be created to improve pain management by increasing the amount of pain assessments and reassessments healthcare providers perform at that healthcare facility. That QI program could also be used as a vehicle for improving patient satisfaction through better pain management. At the enterprise level, that QI program could be used to establish and validate data required for regulatory or other certification requirements.

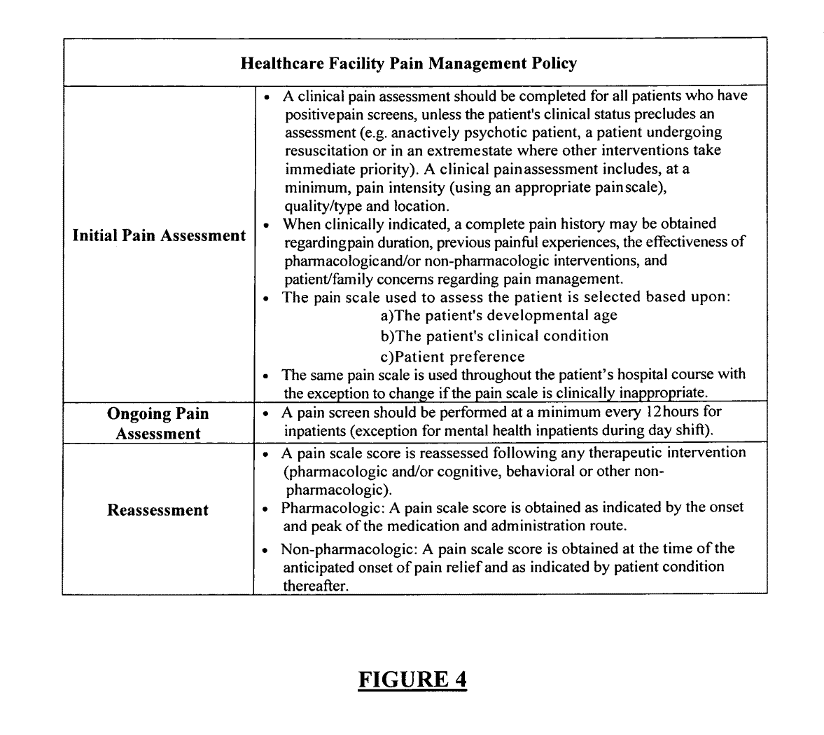

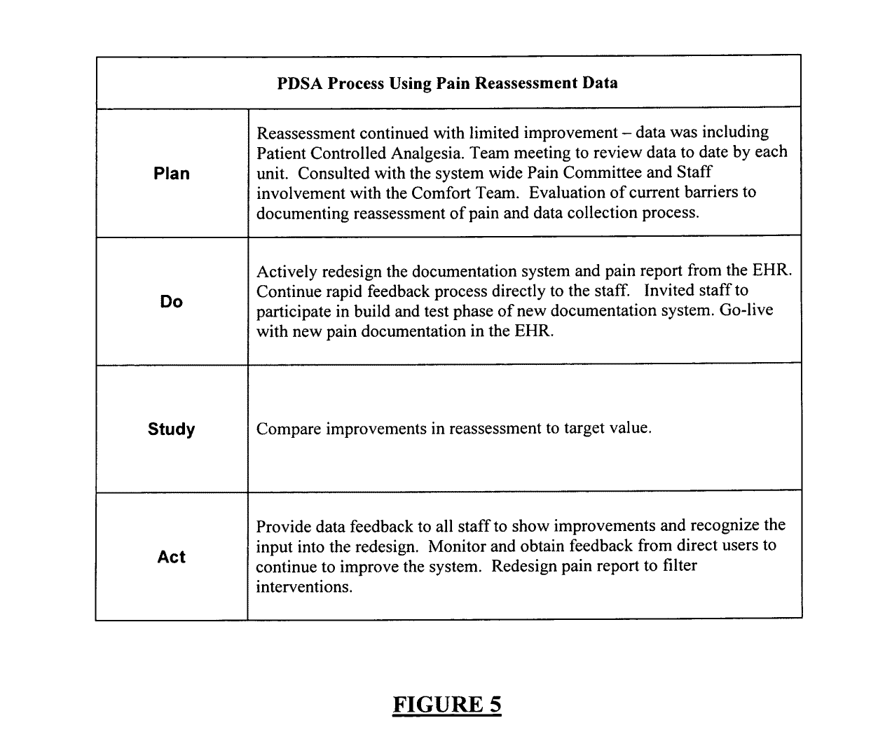

At step 304 of the QIK process 300, healthcare providers establish the policy and procedure that will be followed to implement the QI program created at step 302 of the process. Returning to the example of pain management, step 304 may include adopting a new facility-wide pain management policy and procedure and implementing in as part of a PDSA process that will be repeated in a cyclical, iterative manner such that results closer to the desired goal will be achieved with each iteration. As FIG. 4 illustrates, that policy and procedure 400 includes an initial pain assessment of all patients that have positive pain screens, excluding those patients whose clinical status precludes such an assessment (e.g., an actively psychotic patient, a patient undergoing resuscitation or in an extreme state where other interventions take immediate priority, etc.); ongoing pain assessment at a minimum of every 12 hours for inpatients, excluding mental health inpatients during the day shift; and reassessing following any therapeutic intervention. And as FIG. 5 illustrates, that PDSA process 500 includes holding team meetings to review and evaluate pain assessment documentation, actively redesigning pain assessment documentation in the healthcare facility's EHR system 210, evaluating improvements in pain assessment and comparing them to the target value (i.e., the goal), and obtain feedback from the healthcare providers on that documentation to help further redesign the pain assessment documentation.

If the policy and procedure established at step 304 of the QIK process 300 cannot be accomplished using the existing clinical documentation of the EHR system 210, that documentation may be modified at step 306 of the QIK process 300. In the pain management QI program, for example, fields can be created within existing clinical documentation into which pain assessment data can be entered at the point of care and/or new pain assessment documentation can be created with fields into which pain assessment data can be entered at the point of care. Examples of custom fields that can be created and/or that may already exist in the EHR system 210 and that can be utilized by the QIK functionality of the present invention are listed below:
PERSON_ID: Unqiue identifier for each patient that the computer codes;
ENCTR_ID: Number linked to the patient-specific visit that changes each time a patient visits the healthcare facility for outpatient or inpatient visits;
PT_NAME: Patient Name generated as Last Name, First Name;
PT_GENDER: Patient Gender, Male or Female;
PT_DOB: Patient Date of Birth;
PT_ADMIT_AGE: Patient age at time of the specific encounter related to the date the report is run;
PT_MRN: Patient medical record number, which always stays the same for each patient;
PT_FIN: Patient financial number, which changes with each encounter;
ADMIT_DTTM: Admission date and time for the patient visit to the healthcare facility;
DISCHARGE_DTTM: Discharge date and time for the specific admission that the patient is discharged (may be left blank if the patient is still admitted to the healthcare facility);
ENCNTR_TYPE: Identifies if this is a regular inpatient admission, visit to the ER, Mental health admission, transplant admission, or other type of admission as defined within the EHR system 210;
NURSE_UNIT: Nurse unit, which represents the nursing unit into which the patient is admitted;
PT_ROOM: Denotes the room number in which the patient is admitted;
PT_BED: Identifies the bed number within the room;
ADM_DB_EVNTID: Admission database event identifier, which creates a unique number for each admission database that is completed for a patient;
MULTIPLE_ADM_DB_FLAG: Multiple admission database flags that identifies the total number of admission databases completed for the specific patient admission (one database completed per patient admission);
ADM_DB_DTTM: Admission database date and time identifies the date and time the admission database is completed;
ADM_PAIN_EVENT: Admission pain event identifies the pain scale that was used and completed;
ADM_PAIN_SCORE: Patients pain score at the time of admission;
ADM_PERFORMED_BY: Identifies the healthcare provided that completed the pain documentation in the admission database;
TIME_DIFF_MIN: Time difference in minutes calculated field from the time of patient to admission to the admission database pain section is completed;
SHIFTA_{—}7A: Used to denote if a pain score is completed within a routine 7 AM shift;
SHIFTB_{—}7P: Used to denote if a pain score is completed within a routine 7 PM shift;
INTERVENTION_FLAG: Field to flag data points that need future follow up and to look for errors in data;
DATA_ENTRY TYPE: Identifies the area in the EHR database 208 where the documentation is captured from;
EVENT_ID: Unique number related to analysts ability to review problem areas with data capture;
EVENT_CD: Unique number related to analysts review of problems with data capture;
EVENT_NAME: Pulls data related to ongoing pain scores or interventions that were provided to a specific patient;
EVENT_DT_COMPLETE: Event date and time complete (related to the event name);
HOUR_ONLY: Identifies hour only at which the event was complete;
EVENT_DT: Event date and time that related assessment or intervention for pain completed;
HOUR_OF_DAY: Specific hour that related assessment or intervention for pain completed;
PERFORMED_BY: Identifies healthcare provider that completed the documents, assessment, and/or pain intervention; and
EVENT_RESULT: Includes specifics of the assessment or interventions for pain given to the patient.
   Those fields can be specifically designed and refined to integrate with workflow and evidence based guidelines within the EHR system 210.

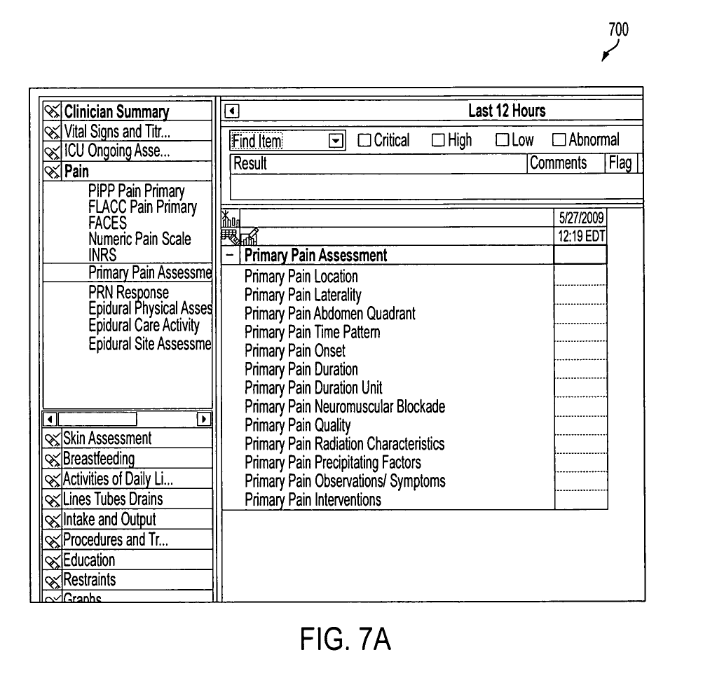

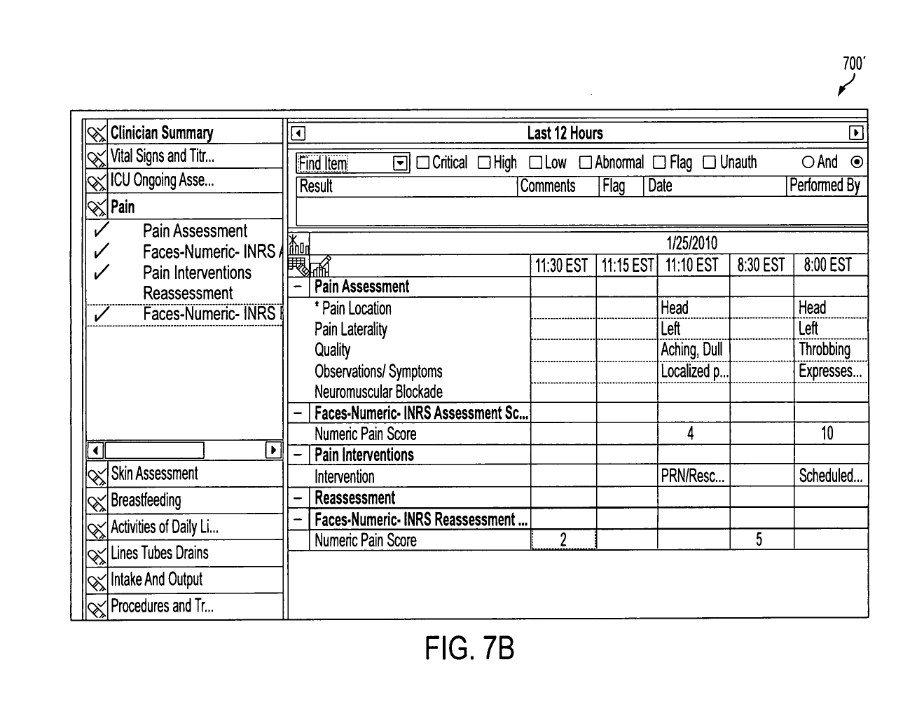

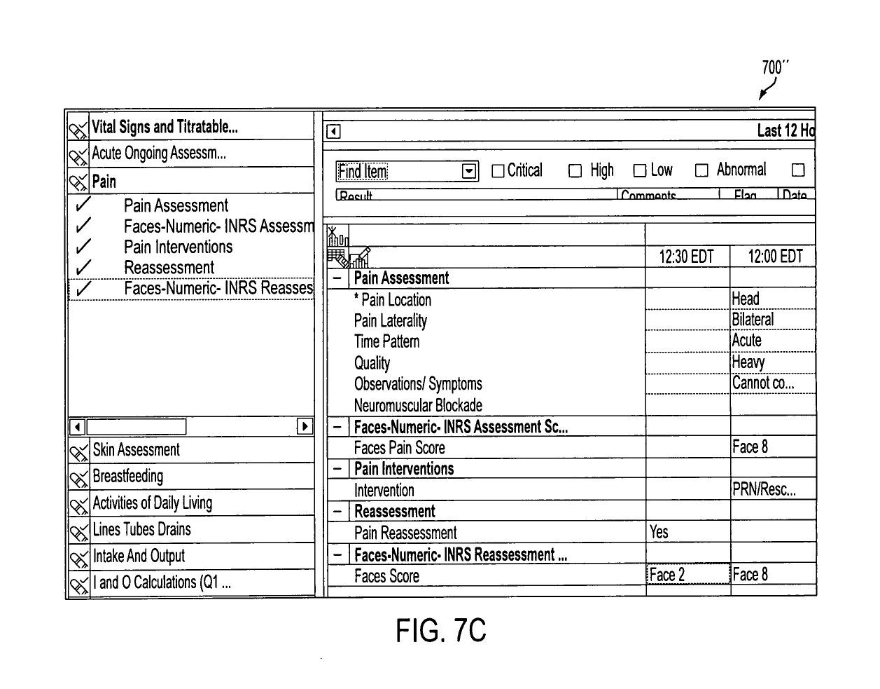

FIG. 6 illustrates an example of existing EHR documentation 600—in particular, a clinical summary—that can be modified to include fields into which pain assessment data can be entered at the point of care. In the example of FIG. 6, the existing EHR documentation 600 provides fields for entering pain assessment data directly into the clinical summary but rather includes links (left column of the clinical summary) to other pain assessment documentation created within the EHR system 210 at step 306. FIGS. 7A-7C illustrate examples of that custom pain assessment documentation 700, 700′ and 700″, wherein healthcare providers can input pain assessment data such as pain scores, pain locations, times of assessment, pain qualities, durations of pain, pain characteristics, pain symptoms, precipitating factors, pain interventions, and other observations made at the point of care.

When using the custom pain assessment documentation 700, 700′, and 700″ illustrated in FIGS. 7A-7C to capture pain assessment data at step 308 of the QIK process 300, healthcare providers preferably use established methods to assess a patient's pain as a number on a pain scale (i.e., a pain score). For pharmacologic interventions, the pain score is obtained as indicated by the onset and peak of the medication and administration route. And for non-pharmacologic interventions, the pain score is obtained at the time of the anticipated onset of pain relief and as indicated by the patient's condition thereafter.

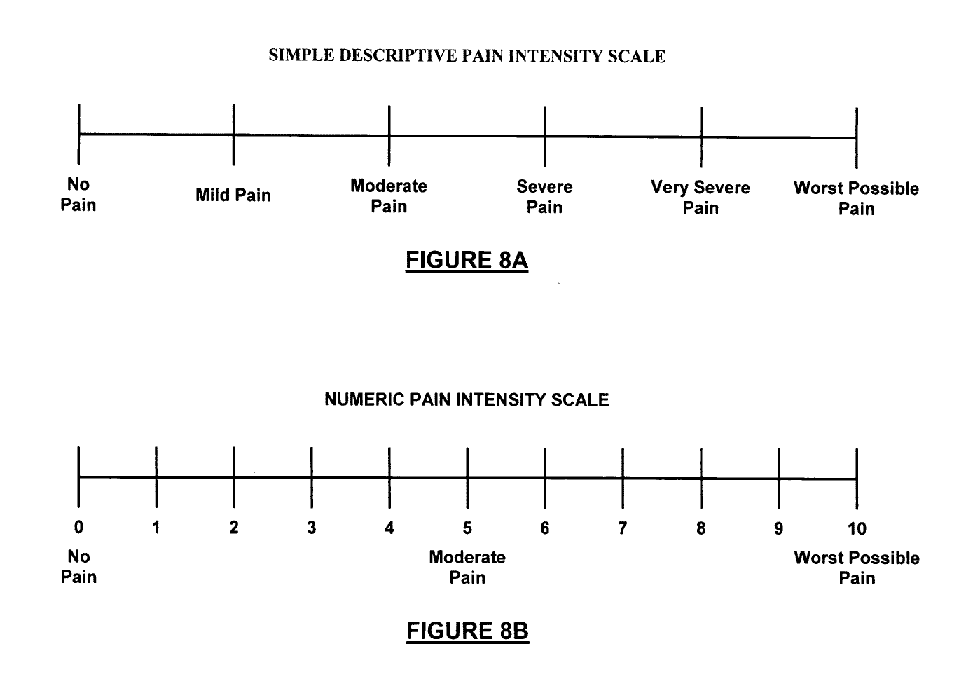

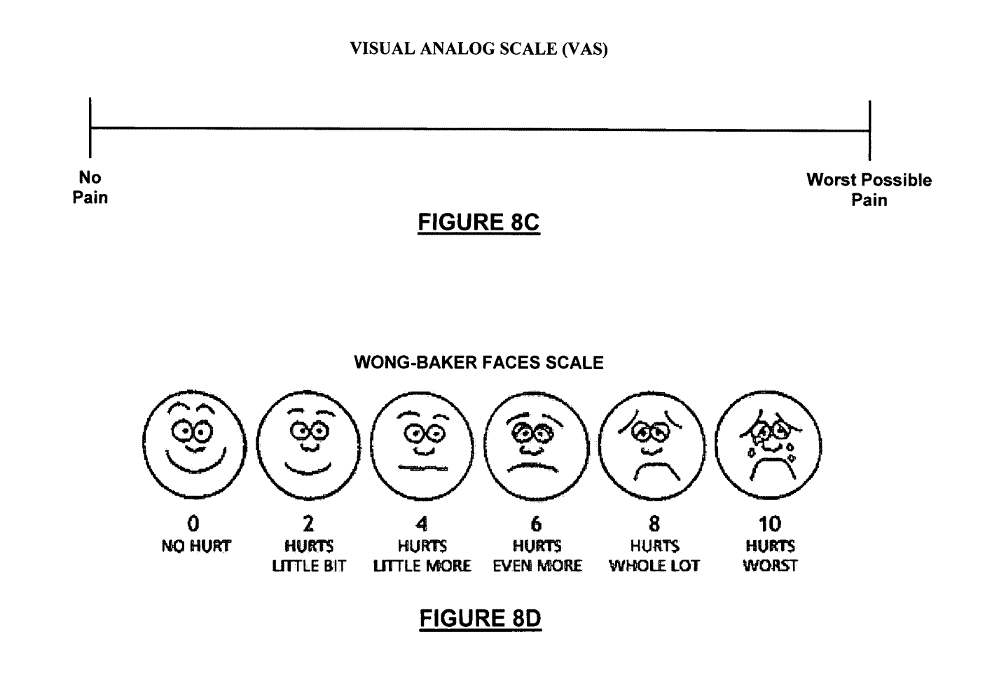

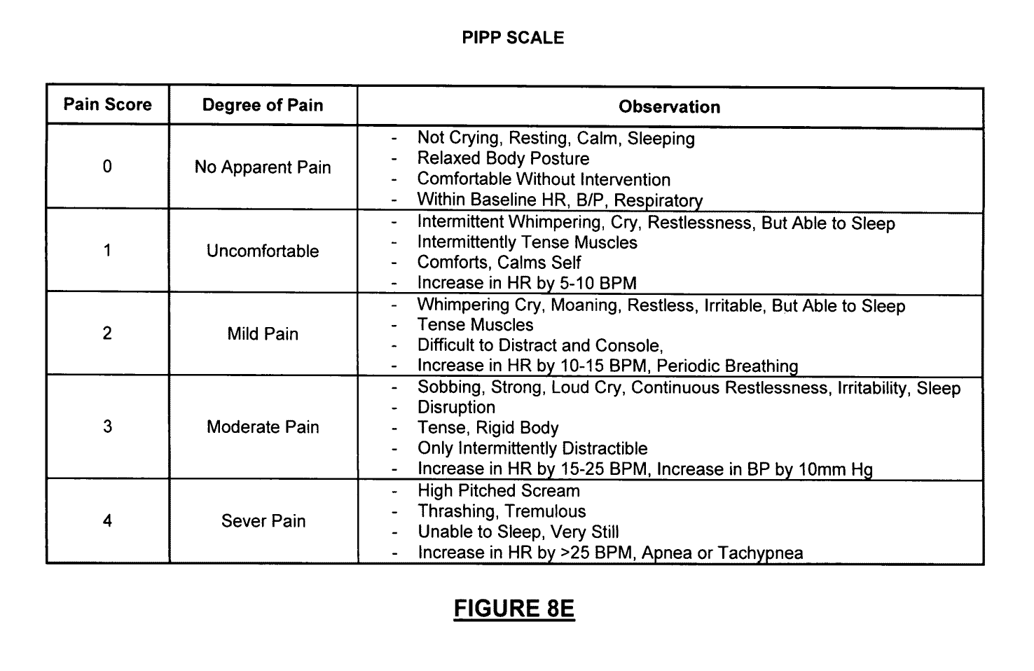

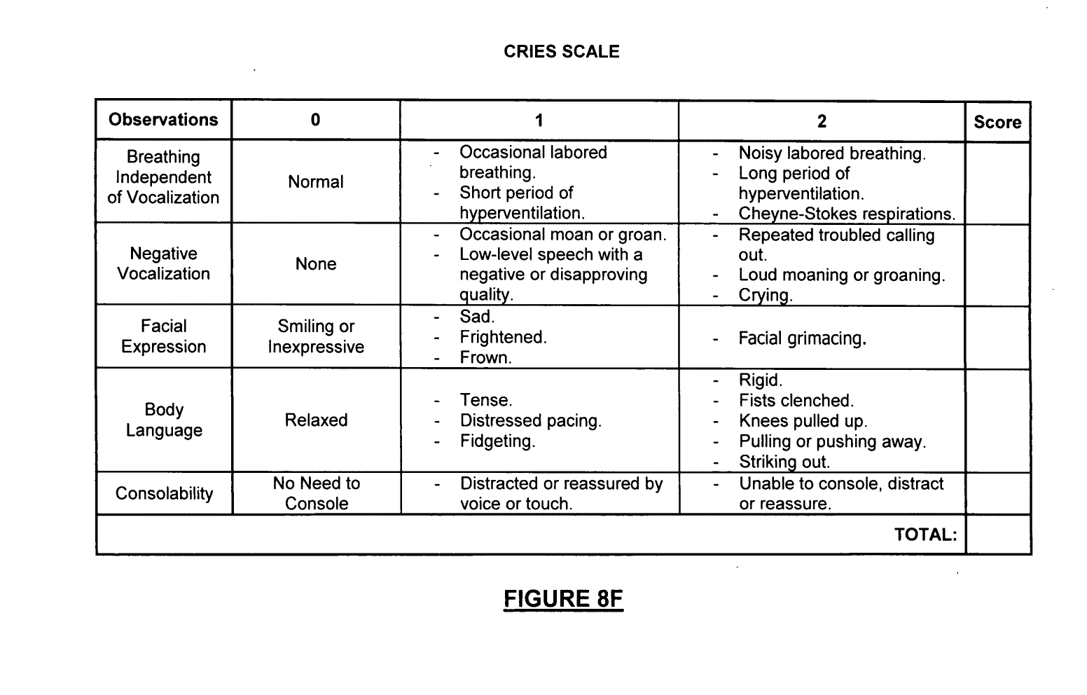

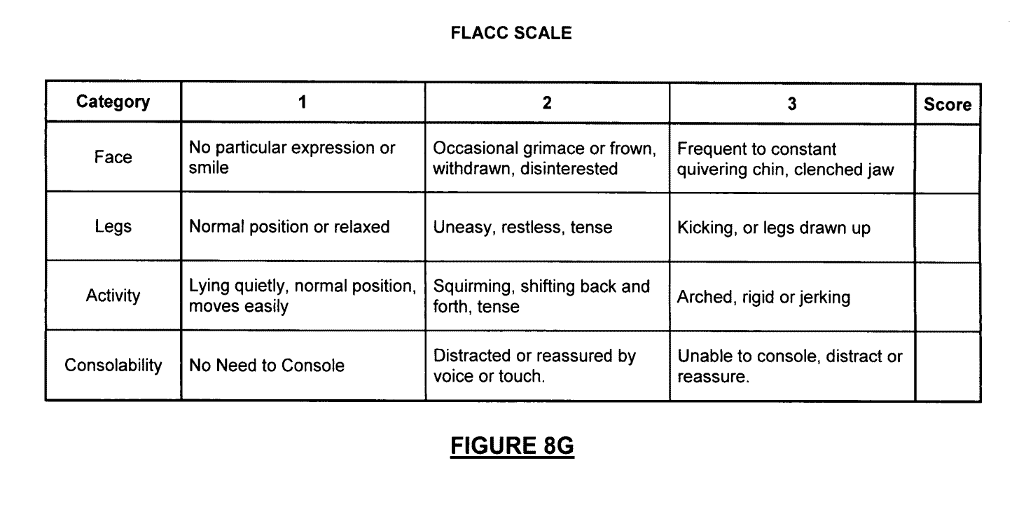

As FIGS. 8A-8G illustrate, the pain scales used to determine those scores may include a verbal pain intensity scale that is used to measure pain intensity based on adjective descriptors (e.g., “no pain”, “mild pain”, “moderate pain”, “severe pain”, “very severe pain”, and “worst pain possible”); a Numerical Pain Scale (NPS) that is used to measure pain intensity based on a numerical rating (e.g., 0 for “no pain” up to 10 for “worst pain possible”); a Visual Analog Scale (VAS) that is used to measure pain intensity based on a position along a continuous line between two endpoints (e.g., the closer to the left end point the closer to “no pain” and the closer to the right end point the closer to “worst pain possible”); a Wong-Baker FACES revised pain intensity scale that is used to measure pain intensity based on a face that best represents how the patient is feeling (e.g., a face with the largest smile for “no hurt” and a face that is crying for “hurts worst”); a Premature Infant Pain Profile (PIPP) pain assessment scale that is used to measure pain based on a score that corresponds to a specific behavioral observation (e.g., a “relaxed body posture” corresponds to “no apparent pain” and “thrashing” corresponds to “severe pain”); a Crying, Requires oxygen, Increased vital signs, Expression, and Sleepless (CRIES) pain assessment scale that is used to measure pain based on a score that is totaled from a plurality of different behavioral observations (e.g., a “normal” breathing corresponds to a score of 0 and “facial grimacing” corresponds to a score of 2); and/or a Face, Legs, Activity, Cry, and Consolability (FLACC) pain assessment scale that is used to measure pain based on rating a patient's behavior in each of those categories (e.g., a “normal” or “relaxed” position corresponds to a score of 0 and “kicking, or legs drawn up”, corresponds to a score of three in the “Legs” category. In the alternative, healthcare providers can use an automated device to determine a pain score for a patient and automatically input that pain score into the appropriate field(s) in the custom pain assessment documentation 700, 700′, and 700″. Such a device is disclosed, for example, in co-pending U.S. application Ser. No. 13/076,239, the contents of which are hereby incorporated by reference in their entirety as if fully set forth herein.

Returning to FIG. 3, fields are added to existing EHR documentation 600 and/or new pain assessment documentation 700, 700′, and 700″ is created within the EHR system 210 by a healthcare provider or other user at step 306 of the QIK process 300 via an input device (e.g., keyboard, mouse, touchscreen, clinical instruments, etc.) at a QIK workstation 206. A healthcare provider or other user may also use a QIK workstation 206 to reorganize existing categories/fields and eliminate ambiguous fields based upon clinical logic (i.e., assessment and diagnosis of a patient based upon clinically acceptable practices, such as a sequence of asking questions of condition, decision of appropriate diagnostic tool, reassessment requirements, etc.). The sequence or order of fields can thereby be rearranged as required to reflect the clinical chronology of use to make the ease and sequence of input more conducive to compliance by healthcare providers. And the clinical logic that drives that sequence of fields and which fields appear in existing EHR documentation 600 and/or new pain assessment documentation 700, 700′, and 700″ will be based upon numerous interviews performed with the appropriate healthcare providers at step 322, whereby a better understanding of what needs/hurdles those healthcare providers have encountered in using the EHR system can be identified and used to improve upon the QIK process 300 via the PDSA framework.

Regardless of whether new fields or new clinical documentation needs to be created to capture pain assessment data, that data is captured at the point of care at step 308 of the QIK process 300 using an input device (e.g., keyboard, mouse, touchscreen, clinical instruments, etc.) at a clinician workstation 206. Substantially any form of clinical data may be input into clinical documentation (e.g., existing EHR documentation 600 and/or custom pain assessment documentation 700, 700′, and 700″) at step 308 using the EHR functionality of the EHR system 210, making the present invention suitable for a wide variety of QI programs beyond just pain management (e.g., clinical efficiency, clinical effectiveness, patient satisfaction, evidence-based medicine, quality care delivery, and safe care delivery). As clinical data is captured with the EHR functionality at step 308, it is stored in the EHR database 208.

At step 310 of the QIK process 300, the QIK system 214 queries and extracts the pertinent clinical data from the EHR database 208 of the EHR system 210. And at step 312 of the QIK process 300, that clinical data is imported into the QIK database 212 for analysis and interpretation at step 314 of the QIK process 300. The step 310 of extracting that data may include extracting the data from the EHR database 208 as a text file so that data can more easily be manipulated; the step 312 of importing may include importing the data into an electronic spreadsheet (e.g., a MICROSOFT EXCEL brand electronic spreadsheet, a COREL QUATRO PRO brand electronic spreadsheet, etc.) to provide accurate and reliable on-demand summaries of that data in a meaningful format; and the step 314 of analyzing and interpreting that data may include post-aggregating and analyzing the data from the electronic spreadsheet with a graphical database tool 900 (e.g., a MICROSOFT ACCESS brand graphical database tool, an OPEN OFFICE BASE brand graphical database tool, a SAS brand graphical database tool, etc.) so that various computations and graphical displays can be generated with that data. Those three steps 310-314 are repeated by the QIK system 214 so as to create a call loop 316 in which the QIK system 214 continuously mines data from the EHR system 210 in real time and analyzes and interprets that data to identify various triggering events.

When the EHR system 210 is Cerner Corp.'s Ambulatory EMR/EHR system, the computer code in File 1 of the Computer Program Listing Appendix submitted herewith provides an example of computer code that can be used to extract data from that EHR system 210 into a MICROSOFT EXCEL brand electronic spreadsheet. The following SQL can be used to import that data from the MICROSOFT EXCEL brand electronic spreadsheet to a MICROSOFT ACCESS brand graphical database tool:

INSERT INTO [New Pain Table]
SELECT [New Import Data].
FROM [New Import Data];

The computer code in File 2 of the Computer Program Listing Appendix submitted herewith provides an example of computer code that can be used to manipulate the data imported to the MICROSOFT ACCESS brand graphical database tool—in particular, to assign a unit base on a room and bed number, to separate and erase “F” from a pain score field leaving only the pain score digit, and to eliminate negative numbers for times and change them to 30 minutes. And the computer code in File 3 of the Computer Program Listing Appendix submitted herewith provides an example of computer code that can be used to FILTER the data imported to the MICROSOFT ACCESS brand graphical database tool—in particular, to remove all data not necessary for the analysis at step 314 of the QIK process 300 and to arrange the remaining data in a meaningful way. It should be understood, however, the aforementioned computer code is merely an example of how data can be extracted from an EHR system 210 and manipulated and that other computer code could be used to provide similar functionality without departing from the spirit of the present invention.

The schedule for querying and extracting clinical data at step 310 and the manner in which that data is analyzed and interpreted at step 314 are defined by the policy and procedure established at step 304. For a pain management QI program, for example, the QIK system 214 will query the EHR database 208 to identify patients with positive pain screens and will begin extracting each of those patient's data in 12-hour increments. That data includes a patient identifier and a healthcare provider identifier in addition to pain assessment data. In that way, the QIK system 214 can not only monitor whether patients are being given pain assessments every 12 hours, they can also identify individual patient's outcomes and individual healthcare provider's performance in relation to the goals of the QI program.

At step 318 of the QIK process 300, the QIK system 214 utilizes the data extracted, analyzed, and interpreted during steps 310-314 of the call loop 316 to generate reports on the status of the QI program. Those reports can be customized using the functionality of the graphical database tool 900 into which the extracted data is ultimately imported. FIG. 9 illustrates an example of a graphical database tool 900 that has been configured to generate reports on pain assessment in accordance with the policy and procedure illustrated in FIG. 4. In that configuration, a healthcare provider can generate monthly reports, weekly reports, and other summary reports (e.g., shift reports, annual reports, etc.) for pain assessments performed at admission (i.e., Admission Assessment Reports) as well as on pain assessments performed within 24-hours of an intervention (i.e., Intervention Assessment Reports). The column on the right hand side of FIG. 9 lists the dates at which data query and extraction was performed for the pertinent data.

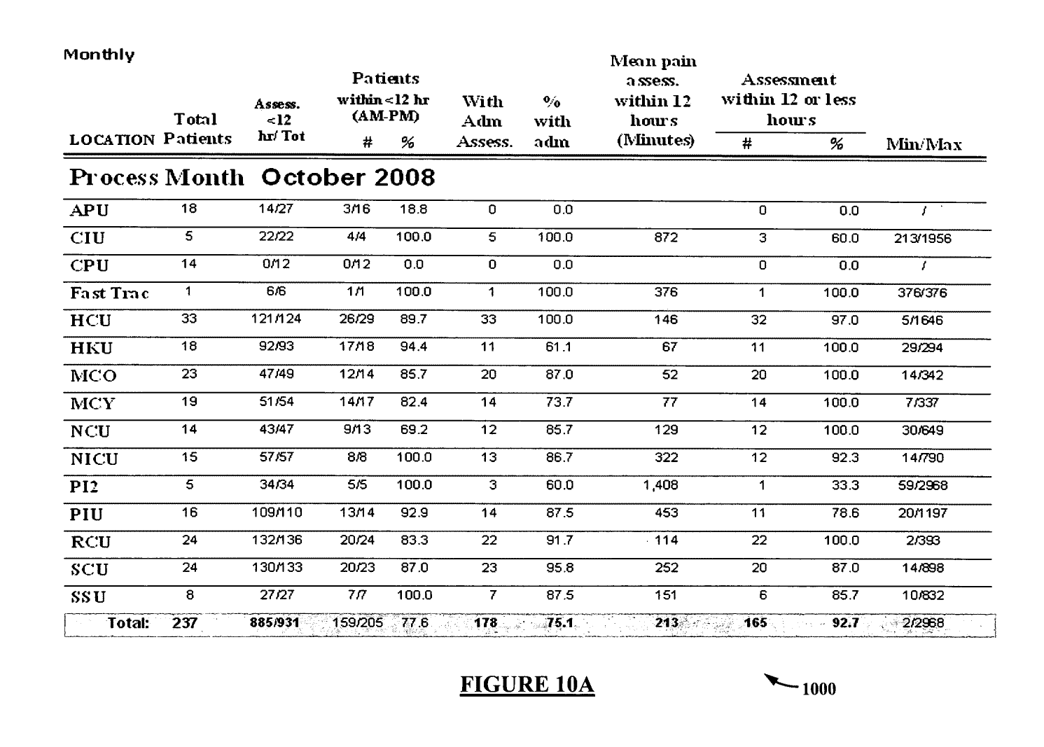

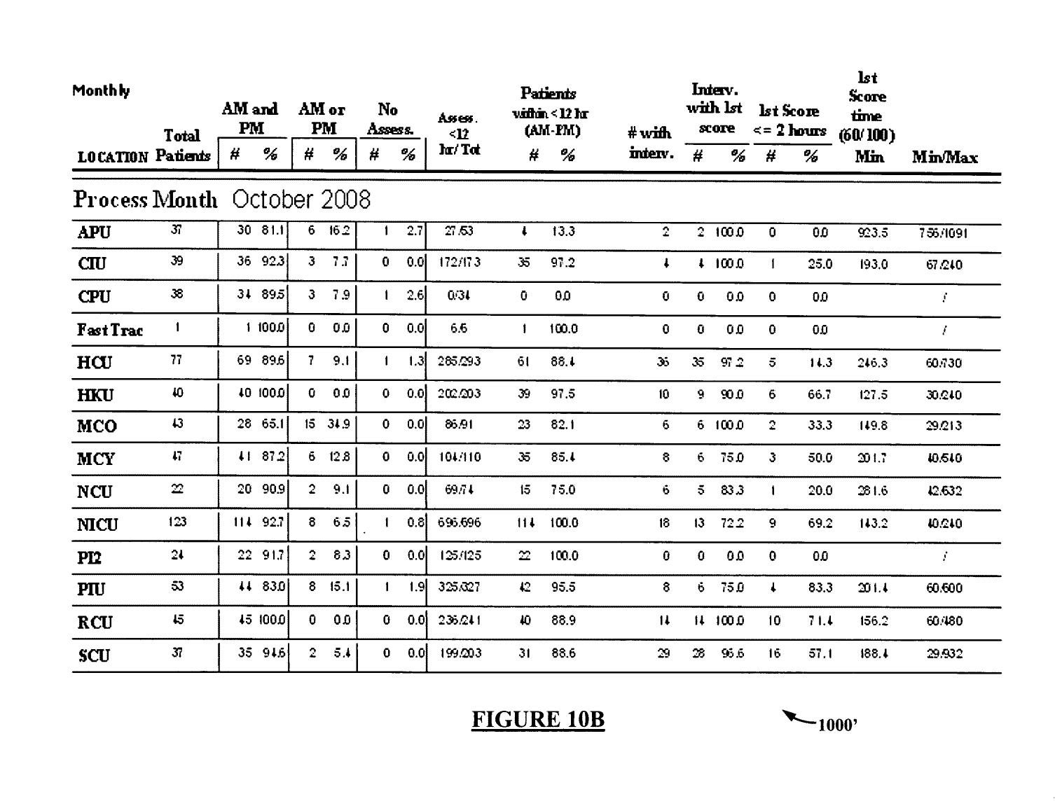

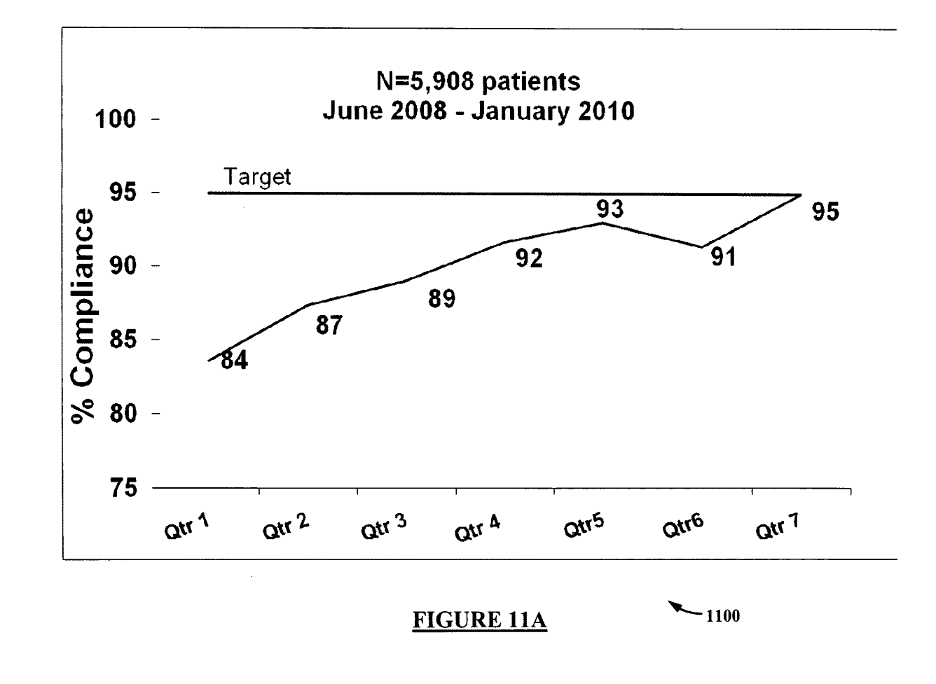

FIG. 10A illustrates an example of Admission Assessment Report 1000 and FIG. 10B illustrates an example of an Intervention Assessment Report 1000′. A description of the data displayed and how that data is used in the Admission Assessment Report 1000 and Intervention Assessment Report 1000′ is provided below in Table 1 and Table 2, respectively.

TABLE 1

| Heading | Description | Calculation |
|---|---|---|
| Location | Inpatient unit where the | Sum # of patients at extraction |
| | patient is admitted. | location |
| Total Patients | Total number of patients | Random sample or sum of all patients |
| | sampled in a specific | in the area when the report is |
| | location | generated |
| Patients within | Number and % of patients | Sum # of patients with second |
| 12< hr | who had a second | assessment taken within 12 hours of |
| (AM-PM) | assessment taken within | the previous assessment for the 7 AM |
| | 12 hours of the previous | to 7 PM shift, divide by “Total |
| | assessment for the 7 AM | Patients”, and multiply by 100 |
| | to 7 PM shift | |
| With Adm. | Number of patients that | Sum # of patients with pain completed |
| Assess. | had pain assessment | pain assessment |
| | completed at admission | |
| % with adm | Percentage of patients | Divide “With Adm. Assess.” by |
| | with a completed pain assessment | “Total Patients” and multiply by 100 |
| Mean pain | Mean time to complete a | Subtract admission time from |
| assess within | pain assessment within 12 | subsequent assessment time |
| 12 hours | hours of admission | |
| Assessment | Number and % of patients | Identify ad sum # of patients for |
| within 12 hours | that had a pain assessment | whom the value of “Mean pain assess |
| or less # | completed within 12 hours | within 12 hours” is ≦12, divide by |
| | or less of admission | “Total Patients”, and multiply by 100 |
| Min/Max | Range of time to complete | Subtract time of admission from time |
| | a pain assessment at | subsequent assessment completed |
| | admission | (minimum and maximum) and sum |
| | | for each “Location” |

TABLE 2

| Heading | Description | Calculation |
|---|---|---|
| Location | Inpatient Unit where the | Sum # of patients at extraction |
| | patient is admitted. | location |
| Total | Total number of patients | Random sample or sum of all |
| Patients | sampled in a specific | patients in the area when the |
| | location when the report | report is generated |
| | is generated | |
| AM and | Number and % of | Sum # of assessments during |
| PM | assessments made during | 7 AM to 7 PM shift AND # of |
| | both the 7AM and 7 PM | assessments during 7 PM to |
| | shifts | 7 AM shift |
| AM or | Number and % of | Sum # of assessments during |
| PM | assessments made during | 7 AM to 7 PM shift OR sum # of |
| | one of the two shifts in a | assessments during 7 PM to 7 AM |
| | 24-hour period | shift |
| No | Number and % of | Sum # assessments NOT taken |
| Assess. | assessments NOT made | either during 7 AM to 7 PM shift |
| | during a 24-hour period | or 7 PM to 7 AM shift |
| Patients | Number and % of | Sum # of patients with second |
| within | patients who had a | assessment taken within 12 hours |
| <12 hr | second assessment taken | of the previous assessment |
| (AM-PM) | within 12 hours of the | for the 7 AM to 7 PM shift, divide |
| | previous assessment for | by “Total Patients”, and multiply |
| | the 7 AM to 7 PM shift | by 100 |
| # with | Total number of patients | Sum # of interventions |
| interv. | that received an | administered to patient |
| | intervention for pain | |
| Interv. | Number and % of | Sum # of reassessments completed |
| with | patients that were | following intervention, divide by |
| 1st score | reassessed for pain | “# with interv.”, and multiply |
| | following a pain | by * 100 |
| | intervention | |
| 1^{st} score | Number and % of | Subtract time of intervention from |
| <= 2 | reassessments completed | time of reassessment, identify and |
| hours | within 2 hours following | sum # of patients for whom that |
| | an intervention for pain | result is ≦2 hours, divide by “# |
| | | with interv.”, and multiply by 100 |
| 1^{st} score | Time to first pain | Subtract time of intervention from |
| time | assessment following an | time of subsequent assessment |
| (60/100) | intervention for pain | |
| Min | | |
| Min/Max | Range of time to pain | Subtract time of intervention from |
| | assessment following an | time subsequent assessment |
| | intervention | completed (minimum and |
| | | maximum) and sum for each |
| | | “Location” |

Other clinical data may be manipulated and presented in other reports in a similar manner.

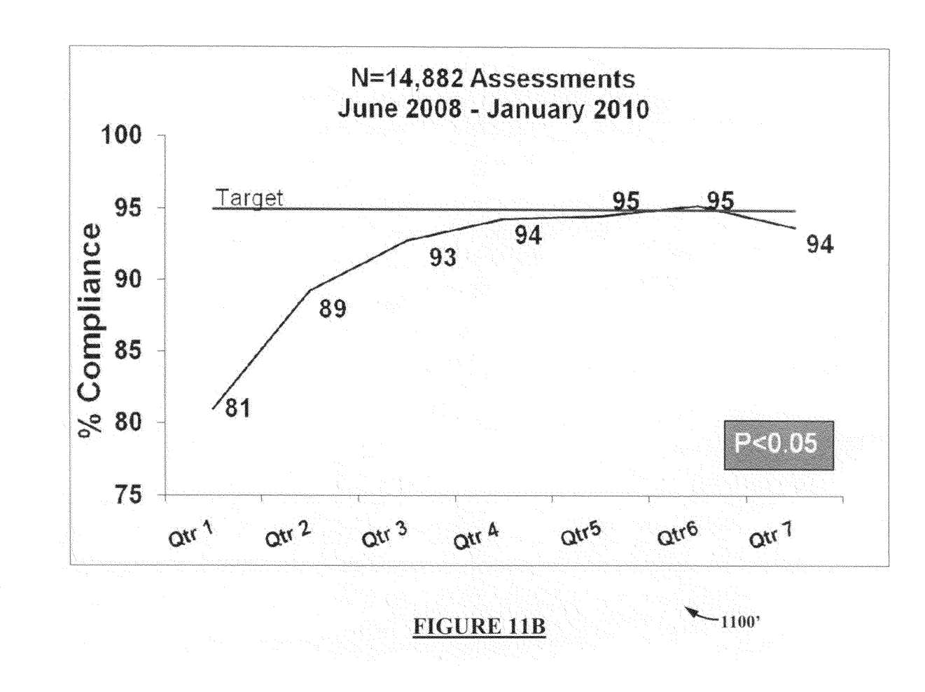

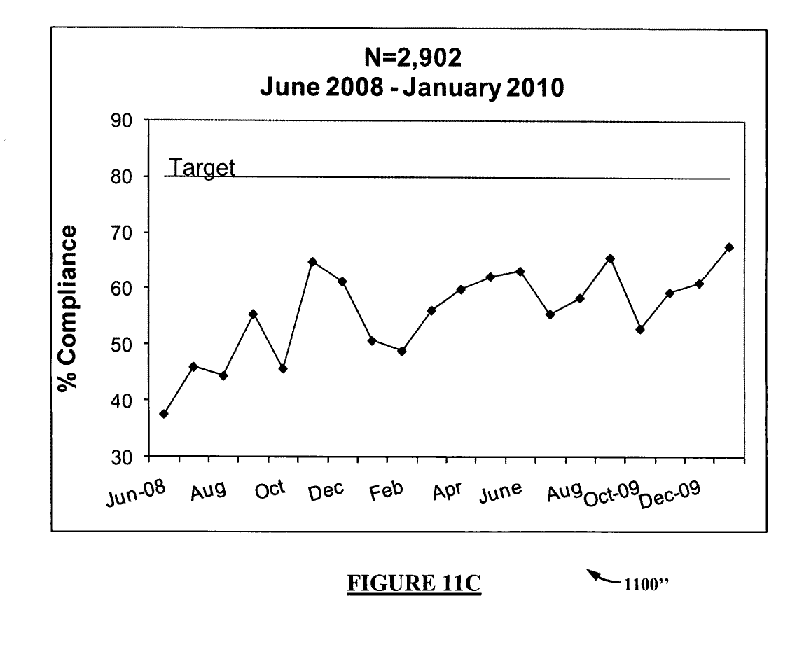

At step 318 of the QIK process 300, the QIK system 214 also utilizes the data extracted, analyzed, and interpreted during steps 310-314 of the call loop 316 to generate a graphical representation of the status of the QI program. Those graphical representations can also be customized using the functionality of the graphical database tool 900. In FIGS. 11A-11C, for example, the functionality of the graphical database tool 900 has been used to create Progress Reports 1100, 1100′, and 1100″ that include graphical representations of healthcare providers' compliance with the policies and procedures of a QI program as compared to the goal (i.e., the “target” value) that is to be achieved by that QI program. More particularly, FIG. 11A illustrates an improvement from 84% compliance to the target value of 95% compliance for performing pain assessments at admission from June 2008 to January 2010 (i.e., a summary of Admission Assessment Reports 1000 from June 2008 to January 2010); FIG. 11B illustrates an improvement from 81% compliance to 94% for performing pain assessments during certain healthcare providers' shifts from June 2008 to January 2010 (i.e., a summary of Shift Assessment Reports (not shown) from June 2008 to January 2010); and FIG. 11C illustrates an improvement from 37% compliance to 68% compliance for performing pain reassessments within two hours of an intervention from June 2008 to January 2010 (i.e., a summary of Intervention Assessment Reports 1000′ from June 2008 to January 2010).

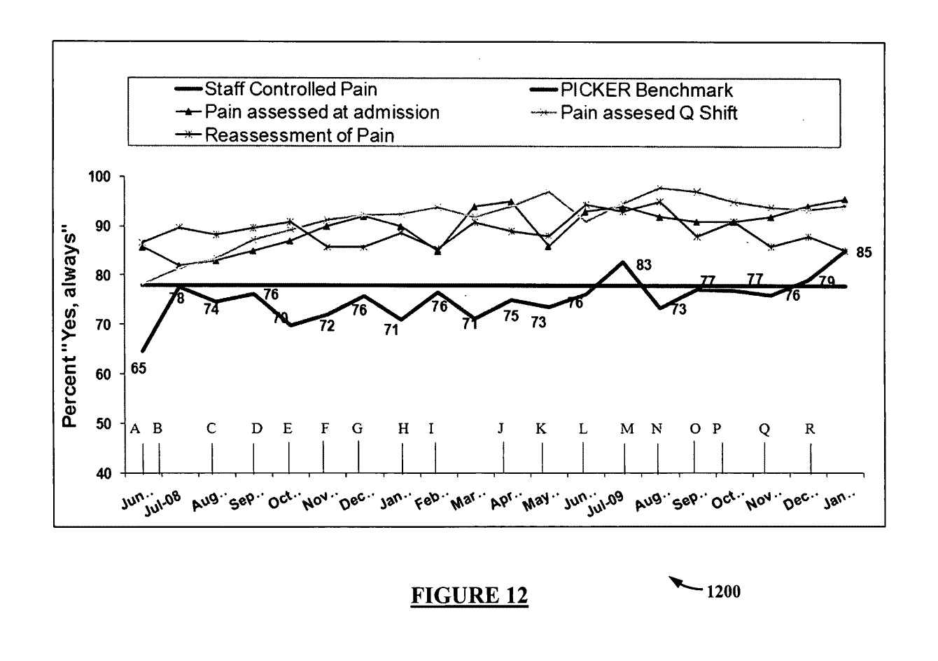

Although FIGS. 11A-11C illustrate separate reports 1100, 1100′, 1100″ with separate graphical representations of separate pain assessment policies and procedures, the graphical database tool 900 can also be used to combine the associated data into a single graphical representation, or comparative report 1200. As FIG. 12 illustrates, that data can not only be combined into a single graphical representation to provide a side-by-side comparison of different types of pain assessment and reassessment, it can be also used to provide a side-by-side comparison with certain established benchmarks (e.g., a Picker Institute benchmarks) to determine how healthcare providers are performing with respect to those benchmarks.

As FIG. 12 also illustrates, the graphical database tool 900 can also be used to plot the percentages of pain assessment and reassessment compliance with respect to certain events related to the QI program. In FIG. 12, the following events have been plotted with respect to the assessment and reassessment data:
A. Automation of Report; Pain Committee; Nursing Pain Lecture
B. Add APN to Pain Service
C. Present Pain Data to Nursing Leadership & Shared Councils
D. Sharing of Pain Data; Pain Data Storyboards
E. RN Comfort Team
F. Pain education: residents, unit directors & nursing staff
G. Quarterly Recognition program
H. Managing Needlestick Pain Project
I. Unit Care Delivery Teams Pain improvement plans
J. Redesign of Pain Documentation Flowsheet
K. Education and dissemination of new Flowsheet
L. Go-Live with new Flowsheet
M. Individual clinician feedback program
N. Redesign of more effective Pain Reports
O. Pain Awareness Event
P. Revised Pain Policies
Q. Annual training of the Comfort Team, addition of new staff
R. Expansion of Pain Committee, focus on Palliative Care
   Because each of those events is related to the pain management QI program, plotting them with the percentages of pain assessment and reassessment compliance allows healthcare providers to determine the effectiveness of those events in helping achieve the goals of the QI program based on trends observed in the corresponding pain assessment data.

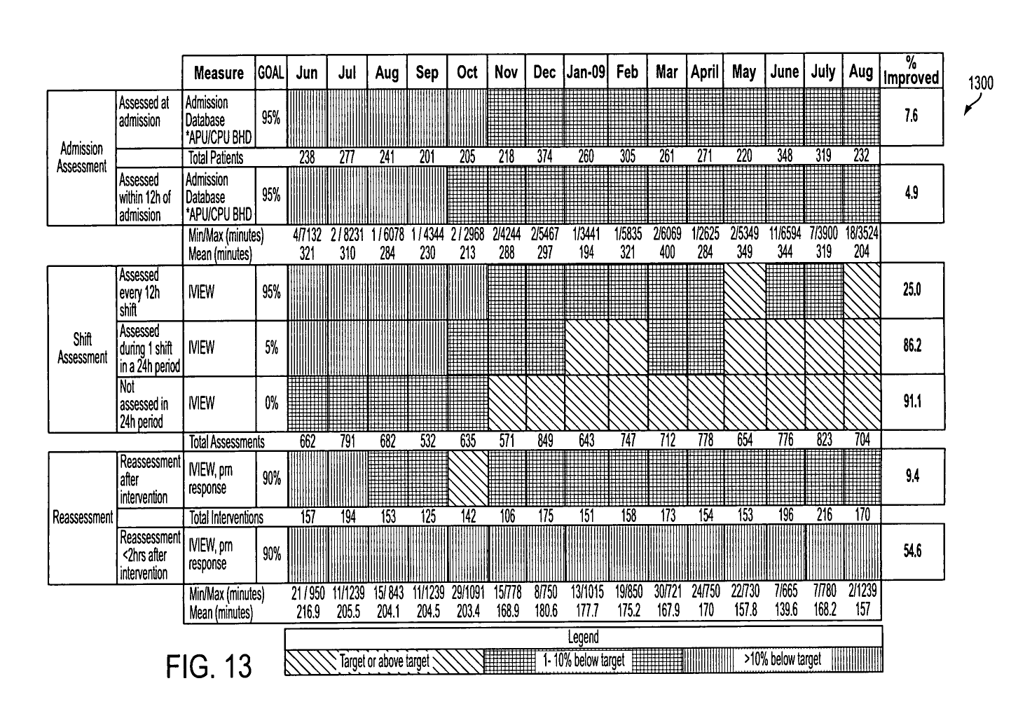

FIG. 13 illustrates yet another example of a graphical representation of pain assessment and reassessment data that can be generated with the graphical database tool 900 of the QIK system 124. FIG. 13 provides a color-coded table report 1300 that indicates how healthcare providers are performing with respect to different types of pain assessment and reassessment on a month-to-month basis. Where healthcare providers are more than 10% below the target value of compliance, the corresponding month is colored red; where healthcare providers are 1%-10% below the target value of compliance, the corresponding month is colored yellow; and where healthcare providers are at or above the target value of compliance, the corresponding month is colored green. The color-coded table report 1300 also indicates the overall percentage of improvement (or setback) occurred for each type of pain assessment and reassessment over the designated months.

In FIGS. 10-13, the reports are 1000-1300 are generated for all of the healthcare providers at a specific healthcare facility. But because patient identifiers and healthcare providers are extracted from the EHR system 210 at step 310 of the QIK process 300, those identifiers can be used to generate similar reports for individual patients, groups of patients, individual healthcare providers, groups of healthcare providers, and/or combinations thereof. Those reports 1000-1300 are then disseminated to the appropriate parties at step 320 of the QIK process 300. As part of the dissemination step 320, those reports can be posted in central locations (e.g., poster boards at nursing stations, etc.) where they can be viewed by all parties for whom the data corresponds, they can be handed out or electronically delivered (e.g., e-mail, facsimile, etc.) to the respective parties, or they can be published or linked to website that can be accessed by the respective parties. And after those reports 1000-1300 are disseminated to the appropriate parties at step 320, they are used at step 322 to conduct performance reviews/evaluations with the appropriate healthcare providers and to monitor the progress those healthcare providers are making toward the goals of the QI program.

For example, reports 1000-1300 can be generated for specific patients and used to evaluate patient care objectives and outcomes for those patients; reports 1000-1300 can be generated for specific departments, units, or staff within a healthcare facility and used to evaluate their performance and to conduct performance reviews; and reports 1000-1300 can be generated for an entire healthcare facility and used to evaluate overall improvements within the healthcare facility. Based on the results of those reviews/evaluations at step 322 of the QIK process 300, the policy and procedures developed at step 302 of the QIK process 300 can be modified as needed to better work toward the goals of the QI program. Steps 302-322 of the QIK process 300 can be repeated in that manner in a PDSA loop 324 until those goals are achieved at step 326.

As should be understood from the above description, the steps of the PDSA process 500 of FIG. 5 are implemented within the steps of the PDSA loop 324 of FIG. 3. For example, the step of holding team meetings to review and evaluate pain assessment documentation can be performed as part of the step 304 of establishing the policy and procedure that will be followed to implement the QI program; the step of actively redesigning pain assessment documentation in the healthcare facility's EHR system 210 can be performed as part of the step 306 of modifying EHR documentation; the step of evaluating improvements in pain assessment and comparing them to the target value (i.e., the goal) can be performed as part of the step 320 of monitoring and/or evaluating the progress of the process 300; and the step of obtaining feedback from the healthcare providers using that documentation to further redesign that pain assessment documentation can be performed as part of the step 304 of modifying the policy and procedure for implementing the QI program. In that way, the iterative QIK process 300 illustrated in FIG. 3 will be defined at least in part by the PDSA framework adopted at step 304 of that process 300.

By implementing the QIK process 300 of the present invention with an EHR system 210, the previous drawbacks of paper-based processes are largely eliminated—in particular, delays in providing the feedback necessary to iteratively improve performance in accordance with the QI program that would otherwise exist due to the time required to analyze paper documents by hand. The elimination of such delays not only allows QI programs to be implemented more efficiently using a PDSA process, it also allows healthcare providers to utilize rapid cycle techniques to quickly assess and identify opportunities for interventions, make those interventions, and assess the impact of those interventions, thereby allowing healthcare providers to provide better care to their patients. More specifically, the present invention reduces the amount of time to perform such analyses to thirty days or less, whereas paper-based techniques were only performed quarterly. Moreover, the ability of the present invention to quickly extract and analyze large amounts of clinical data from an EHR system 210 allows larger sample sizes to be utilized when performing those analyses, thereby allowing more accurate results to be generated for substantially any type of QI program and/or QIK process 300. More specifically, the present invention allows all of the data on an EHR system 210 to be utilized, where as paper-based techniques were limited in the scope of data reviewed and typically only sampled data from one in every fifteen documents.

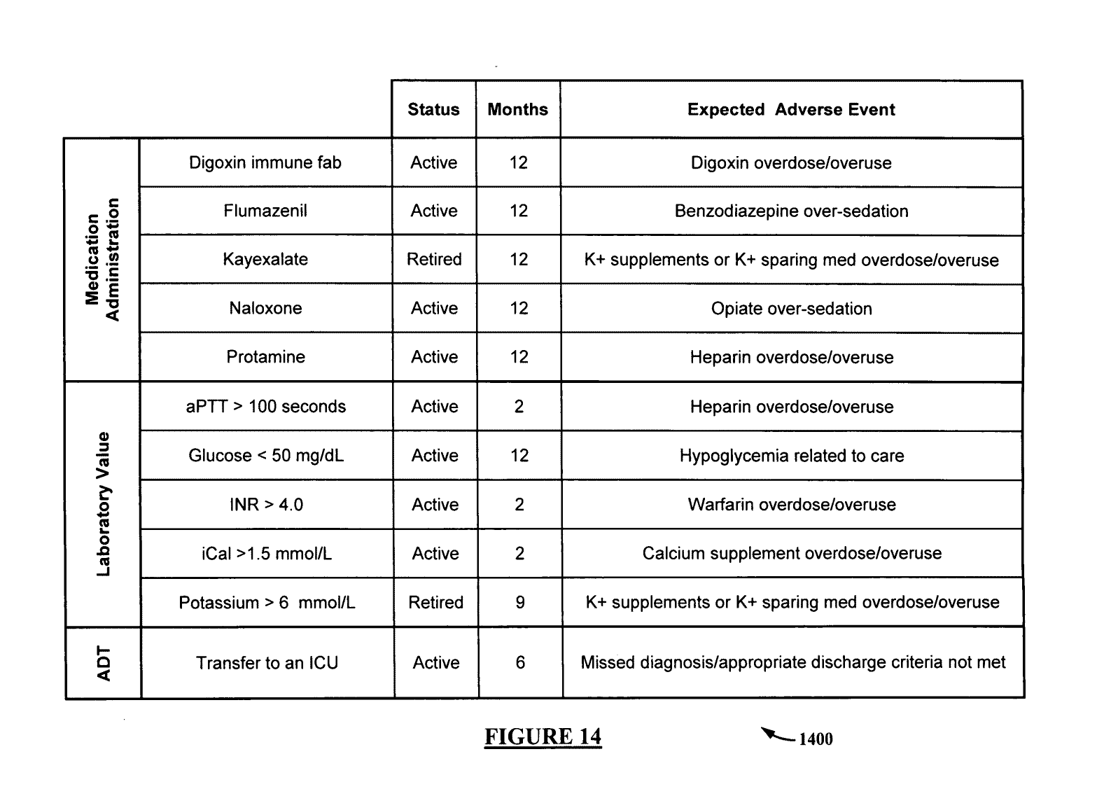

In addition to identifying opportunities for interventions, the present invention can also be used for real-time Automated Adverse Event Detection (AAED) based on the data queried and extracted from the EHR system 210 at step 310 of the QIK process 300. For example, step 304 of the QIK process 300 may include establishing a policy to monitor patients for specific adverse events. As FIG. 14 illustrates, that may involve creating an AE list 1400 that lists the expected Adverse Events (AEs) for certain medications, laboratory values, and Admit/Discharge/Transfer (ADT) events. The EHR system 210 can then be configured to capture data for those medications, laboratory values, and ADT events at step 306 of the QIK process 300 if it is not already configured to do so, and the QIK system 214 can be configured to query and extract that data from the EHR system 210 at step 308 of the QIK process 300. And by repeating the call loop 316 over time, that data can be used to identify AEs as they occur.

Based on the list in FIG. 14, the analysis of clinical data at step 314 of the QIK process 300 will include the identification of various triggering events that correspond to the AEs in the AE list 1400. For example, opiate over-sedation will be identified when analysis of the data identifies a trend of increased Naloxone administration while the patient's pain scores remain the same or increase; hypoglycemia related to care will be identified when the analysis of the data identifies that a patient's glucose level risen to above 50 mg/dL after a change in that patient's insulin protocol; and a missed diagnosis will be identified when the analysis of the data identifies a predetermined number of unexpected ICU transfers that result in AEs. Patients using Patient-Controlled Analgesia (PCA) can also be monitored to prevent identify potential AEs caused by self-administered analgesia when the analgesia administering device is in electronic data communication with the EHR system 210 such that the EHR system 210 captures data for the times, amounts, and types of analgesia the patient is self-administering with the PCA.

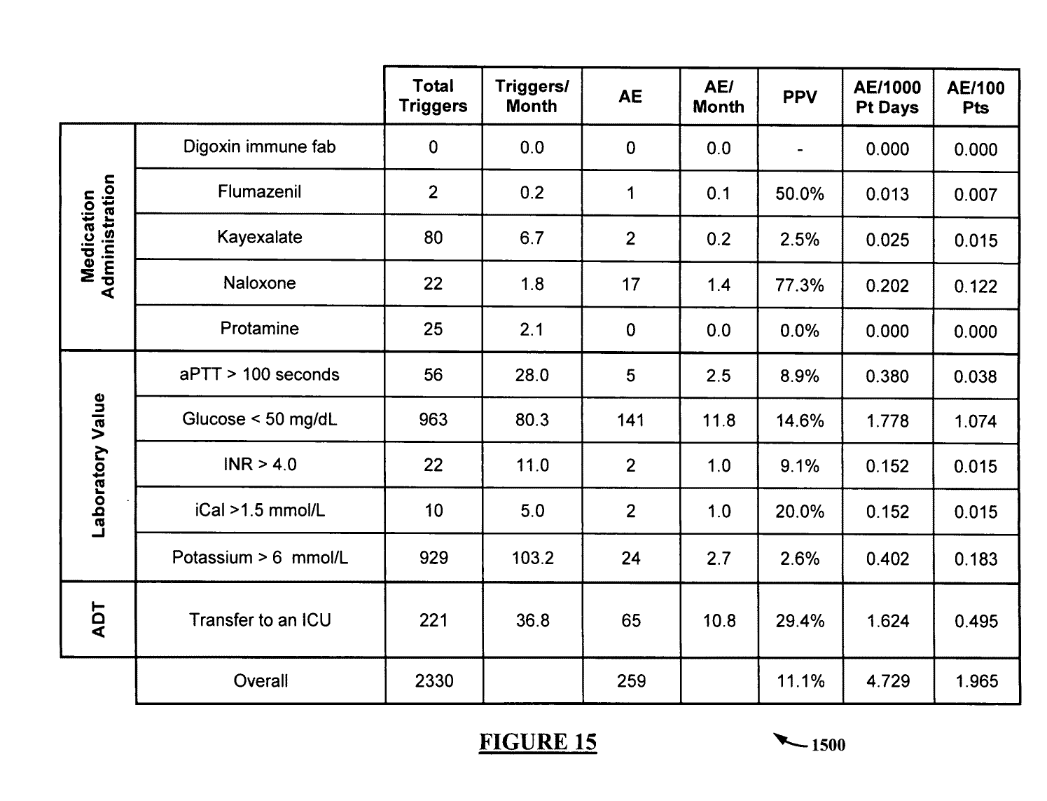

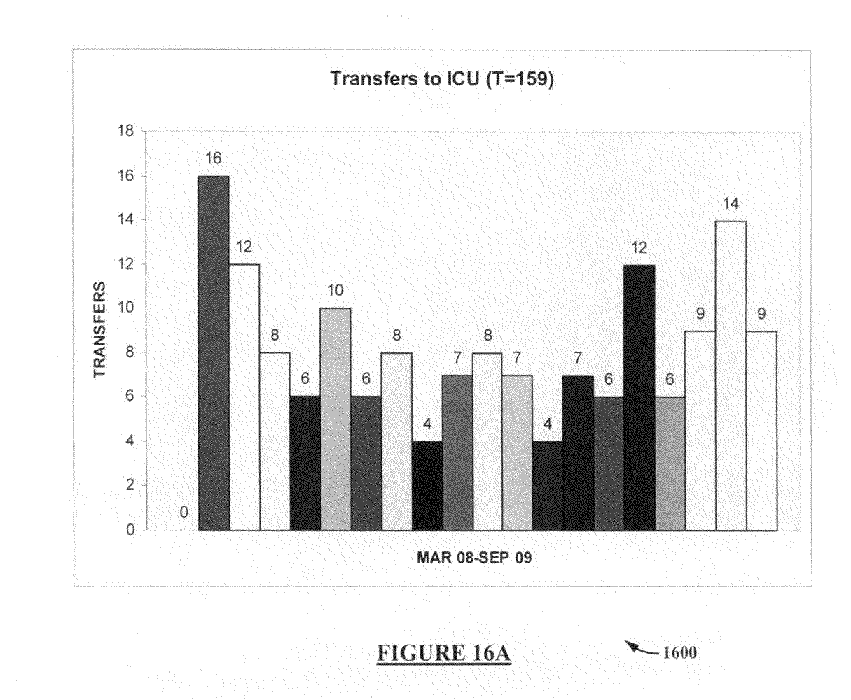

As FIG. 15 illustrates, data for all of the potential AEs identified at step 304 of the QIK process 300 and analyzed at step 314 of the QIK process 300 can be compiled into an AE report 1500 at step 318 of the QIK process 300. That AE report 1500 identifies the total number of triggers (i.e., potential AEs) that occurred over a 10-month period, the average number of triggers each month, the number of actual AEs that occurred over the 10-month period, the average number of AEs each month, the Positive Predictive Value (PPV) for AEs occurring despite a trigger identifying that potential AE, the number of AEs detected per 1000 total patient days (i.e., days patients were admitted to the healthcare facility), and the number of AE detected divided by 100 patients regardless of how long the patient stayed in the healthcare facility. Because some triggering events may be the result of false triggers (e.g., a nurse accidentally charting that she has administered a medication when, in fact, it has not been administered), the PPV is calculated as a(a+b), where “a” is the number triggers that occurred with corresponding AE and “b” is the number of triggers that occurred without a corresponding AE.

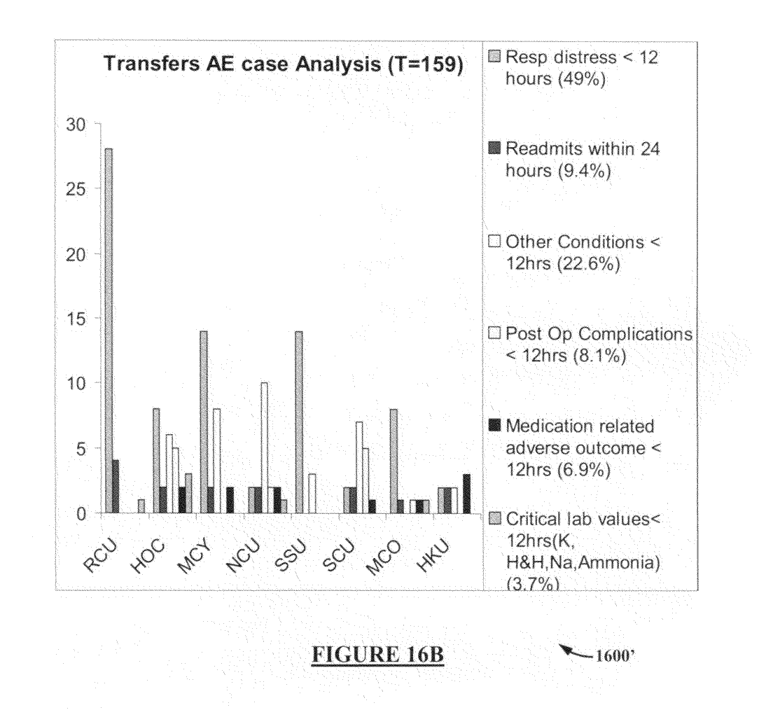

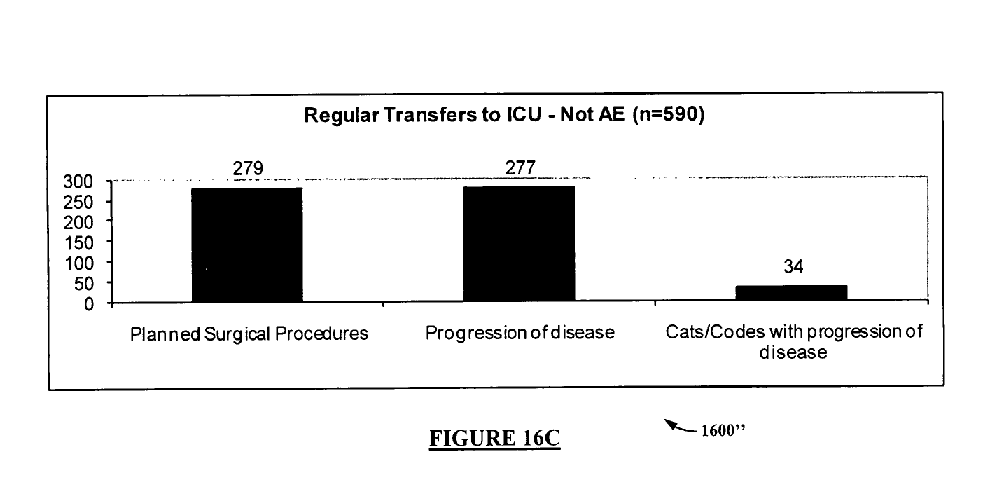

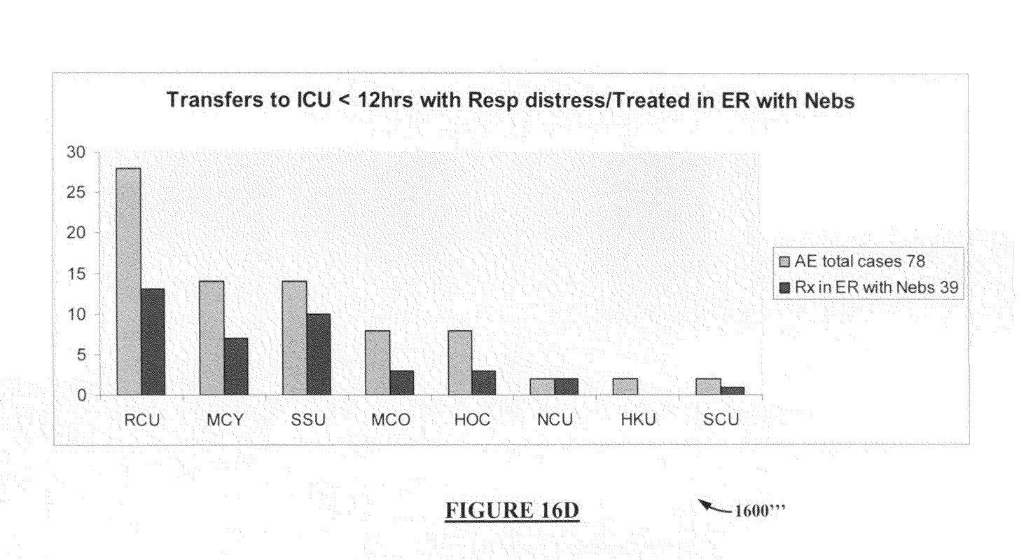

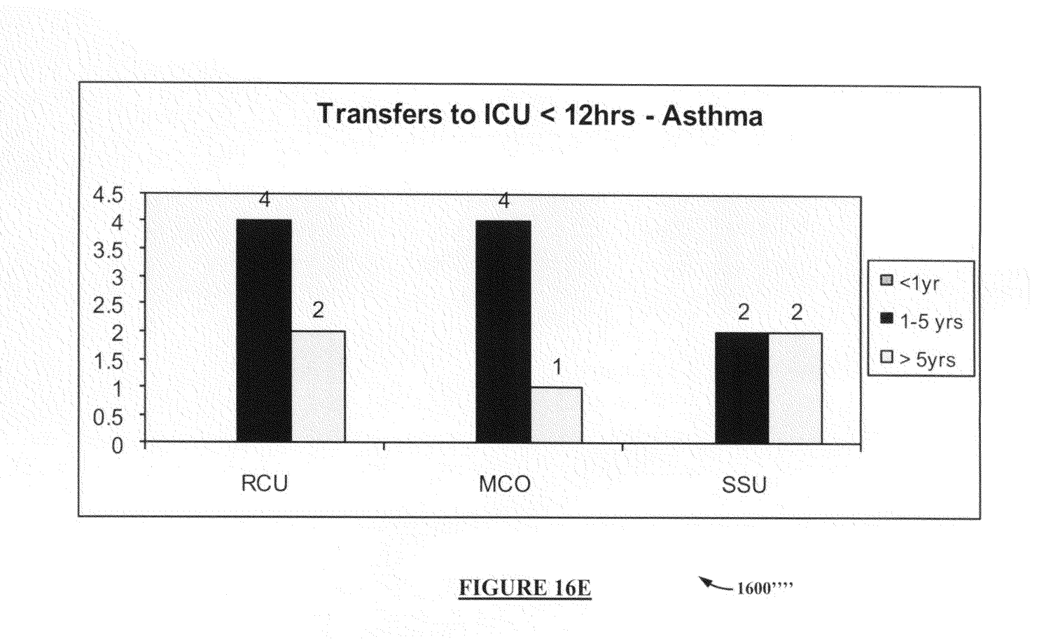

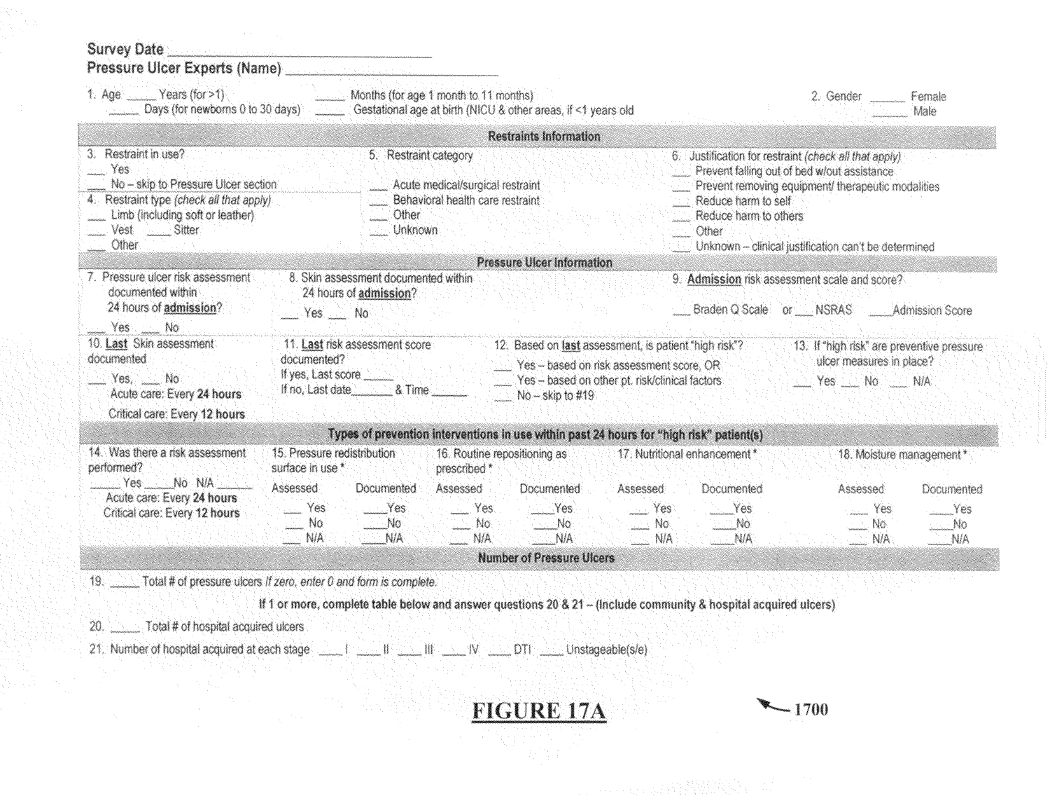

As FIGS. 16A-16E illustrate, more detailed transfer reports 1600, 1600′, 1600″; 1600′″, and 1600″″ can also be generated as part of the AAED functionality of the present invention. FIG. 16A is a bar graph that includes the month-to-month number of transfer events at a healthcare facility from March 2008 through September 2009; FIG. 16B is a bar graph that includes the unit-by-unit number of AEs in six different categories; FIG. 16C is a bar graph that includes the number of transfers to the ICU that were not related to AEs in three different non-AE categories; FIG. 16D is a bar graph that includes the unit-by-unit number of cases transferred to the ICU after first being inappropriately admitted to an acute care bed; and FIG. 16E is a bar graph that includes the unit-by-unit number of cases transferred to the ICU with Asthma after inappropriately being admitted to an acute care unit. Such transfer reports 1600-1600″″ are be generated and distributed to each unit (e.g., Admission Planning Unit (APU), Clinical Investigation Unit (CIU), Cardiopulmonary Unit (CPU), Fast Trac Unit, Heart and Kidney Unit (HKU), High Care Unit (HCU), etc.) at steps 318 and 320 of the QIK process 300. And at step 322 of the QIK process 300, they are used to conduct performance reviews/evaluations with the appropriate healthcare providers and to monitor the progress those healthcare providers are making toward the goals of the QI program at step 322 of the QIK process 300. As a result of those performance reviews/evaluations, the QI program can be modified at step 304 of the QIK process 300 to further improve upon the progress being made by the subject healthcare providers.

For example, reports can be generated on a monthly basis for unexpected transfers to the ICU and reviewed with the appropriate healthcare facility staff (e.g., Emergency Doctor (ED) staff, Prenatal Intensive Care Unit (PICU) staff, Cardiac Intensive Care Unit (CICU) staff, Hospitalists, Hematology/Oncology staff, etc.) to identify ways in which floor admission criteria can be modified to reduce the number of such transfers. As another example of an improvement that can be made based on those performance reviews/evaluations, rules can be defined within the EHR system 210 at step 306 of the QIK process 300 to automatically identify AEs before they occur. Such rules would generate an alert via a clinician workstation 204 or other suitable device (e.g., intercom, pager, cellular phone, smart phone, etc.) to prevent healthcare providers from taking certain actions. Such an alert may be provided in the form of a visual indicator (e.g., a flashing light, a written message, etc.), an audible indicator (e.g., a buzzer, a spoken message, etc.), an electronic communication (e.g., an e-mail, an MMS text message, etc.).

For example, hyperkalemia can be prevented by defining a rule that alerts healthcare providers that potassium supplements should be discontinued when the potassium wasting medications (e.g., antifungals and diuretics) with which they are administered are discontinued; hypercalcemia can be prevented by defining a rule that alerts healthcare providers that a neonate receiving Total Parenteral Nutrition (TPN) should receive a lower dosing of calcium supplements when that neonate is identified as coming off of cardiac bypass. Rules can also be defined for purposes other than preventing healthcare providers from taking certain actions, such as notifying emergency room (ER) and Hospitalist physicians of all transfers to the ICU that occur within 12 hours of admission and routing readmissions to the ICU that occur within 24 hours to the Critical Care Medicine for review. Such alerts can be triggered in real time by the present invention because the call loop 316 of the QIK process 300 can be configured to continuously query and extract the pertinent data from the EHR system 210.

Together, the AAED functionality and the performance monitoring functionality of the present invention can be utilized for a wide variety of clinical applications, including the implementation of QI programs for improving clinical efficiency, clinical effectiveness, patient satisfaction, evidence-based medicine, quality care delivery, and safe care delivery. Such QI programs can be configured as narrowly as to focus on an individual healthcare provider (e.g., a specific clinician), as broadly as to focus on an entire healthcare organization (e.g., a hospital or group of hospitals), or anywhere in between (e.g., a group of staff members at a hospital). Moreover, they can be configured as narrowly as to focus on an individual problem in healthcare (e.g., pressure ulcers), as broadly to focus on an entire area of healthcare (e.g., patient satisfaction), or anywhere in between (e.g., pain management). Accordingly, the present invention can be used to develop QI programs that focus on substantially any number and combination of healthcare providers and healthcare problems.

For example, a QI program can be created at step 302 of the QIK process 300 that is aimed at reducing the amount of pressure ulcers experienced by patients at a specific hospital. That goal may stand on its own or it may be part of a larger goal, such as improving patient satisfaction or ensuing the payability healthcare insurance claims. For example, an insurance provider and/or the Centers for Medicare & Medicaid Services (CMS) may refuse to pay a claim for admissions that result in a hospital acquired pressure ulcer.

In working toward such goals, the policy and procedure established at step 304 of the QIK process 300 could include regularly performing pressure ulcer assessments on patients that are susceptible to pressure ulcers (e.g., bedridden patients, patients in wheelchairs, older patients, patients unable to move certain parts of their bodies without help, etc.). And, if the existing EHR documentation 600 (FIG. 6) provided in the EHR system 210 does not already include the appropriate fields for identifying such patients and performing such ulcer assessments, custom ulcer assessment documentation can be created within the EHR system 210 at step 306 of the QIK process 300.

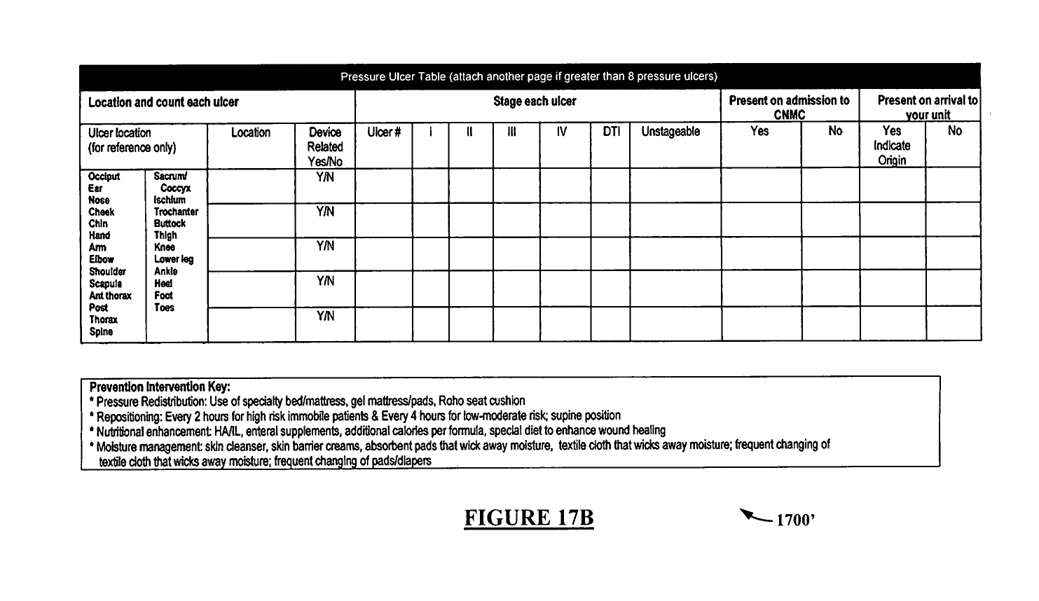

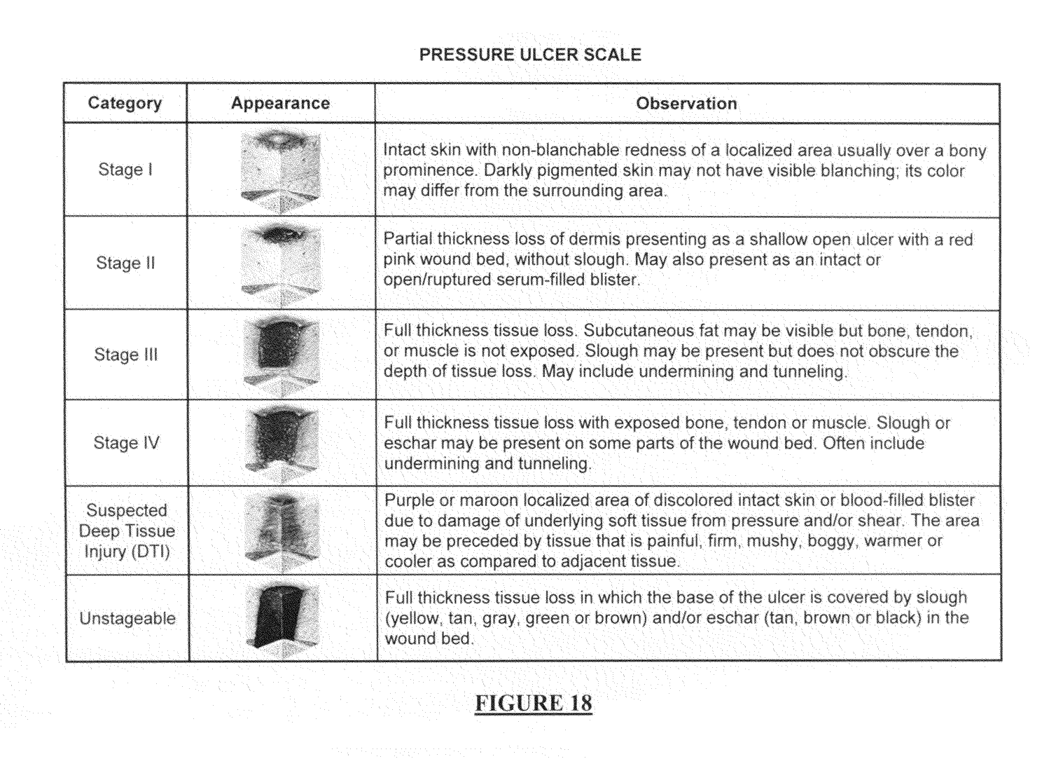

As FIGS. 17A-17C illustrate, such custom ulcer assessment documentation 1700 and 1700′ can be created with fields for identifying whether the patient is being restrained in any way, the risk a patient will develop a pressure ulcer, any preventative interventions in place, the number of pressure ulcers observed, and the location and stage of any such pressure ulcers. Those fields can be completed by a pressure ulcer expert at the point of care at step 308 of the QIK process 300 using a clinician workstation 204. And just as healthcare providers use pain scales to help them complete custom pain assessment documentation 700, 700′, and 700″, healthcare providers can use a pressure ulcer scale to help them complete the customer ulcer assessment documentation 1700 and 1700′. As illustrated in FIG. 18, such a pressure ulcer scale 1800 may illustrate the appearance of each category of pressure ulcer and include written observations describing each category of pressure ulcer. If such scales do not exist, they can be defined as part of the policy and procedure established for the QI program at step 304 of the QIK process 300 and created within the EHR system 210 at step 306 of the QIK process 300.

The clinical data captured at step 308 of the QIK process 300 using the custom ulcer assessment documentation 1700 and 1700′ and the pressure ulcer scale 1800 can then be queried and extracted from the EHR system 210 at step 310 of the QIK process 300, imported into the QIK database 212 at step 312 of the QIK process 300, and analyzed and interpreted at step 314 of the QIK process 300. Those three steps 310-314 are repeated by the QIK system 214 so as to perform a call loop 316 in which the QIK system 214 continuously mines data from the EHR system 210 in real time and analyzes and interprets that data to identify various triggering events. Such triggering events may include the identification of a patient with a limb that has been restrained for a predetermined amount of time without the use of a pressure redistribution surface under that limb, in which case an alert would be generated to instruct the healthcare provider place a pressure redistribution surface under that limb.

At step 318 of the QI process 318, reports would be generated to document such triggers, any resulting AEs, as well as any other data for quantifying the hospital's compliance with the policy and procedures that were established at step 304 of the QIK process 300. And after those reports are disseminated to the appropriate parties at step 320, they can be used at step 322 to conduct performance reviews/evaluations with the appropriate healthcare providers and to monitor the progress those healthcare providers are making toward the goals of the QI program. Any modifications that need to be made to help better achieve those goals can then be made at step 302 of the QIK process 300, thereby initiating another iteration of the PDSA loop 324, which can be repeated until those goals are reached at step 326 of the QIK process 300.

Yet another example of a QI program than can be implemented with the apparatus and method of the present invention is one that is aimed more generally at improving patient satisfaction at a hospital. Understanding the patient experience and measuring patient satisfaction is becoming increasingly important as healthcare organizations strive to improve processes and products, become more patient centric, and improve profitability. Moreover, patient perceptions of quality relate to hospital financial performance. That QI program would be created at step 302 of the QIK process 300. And the corresponding policy and procedure established at step 304 of the QIK process 300 could include surveying patients during inpatient care, before they leave the healthcare facility. Such a policy and procedure eliminates the problems associated with retrospective surveys—in particular, the fact that patients tend to give more favorable responses after being discharged after only a short stay at a healthcare facility compared to those who had to stay longer, or that retrospective surveys often “roll over” quarterly reporting periods making the relationship of the survey outcomes to the current quarter practices unclear. And the utilization of an EHR system 210 to collect that data greatly increases the sample size.

Because existing EHR documentation 600 (FIG. 6) generally does not exist for such surveys, customer survey documentation would be created within the EHR system 210 at step 306 of the QIK process 300. Clinician workstations 204, or other suitable computing devices, would then be placed in patients' rooms to allow those patients to complete that documentation during their inpatient stay at step 308 of the QIK process 300. In the alternative, a stand-alone customer satisfaction system (not shown) could be integrated into the QIK network 200 (e.g., the GETWELL brand customer satisfaction system provided at Children's National Medical Center). In either configuration, the QIK system 214 could be used to query, extract, analyze, and interpret the pertinent survey data at steps 310-314 of the QIK process 300.

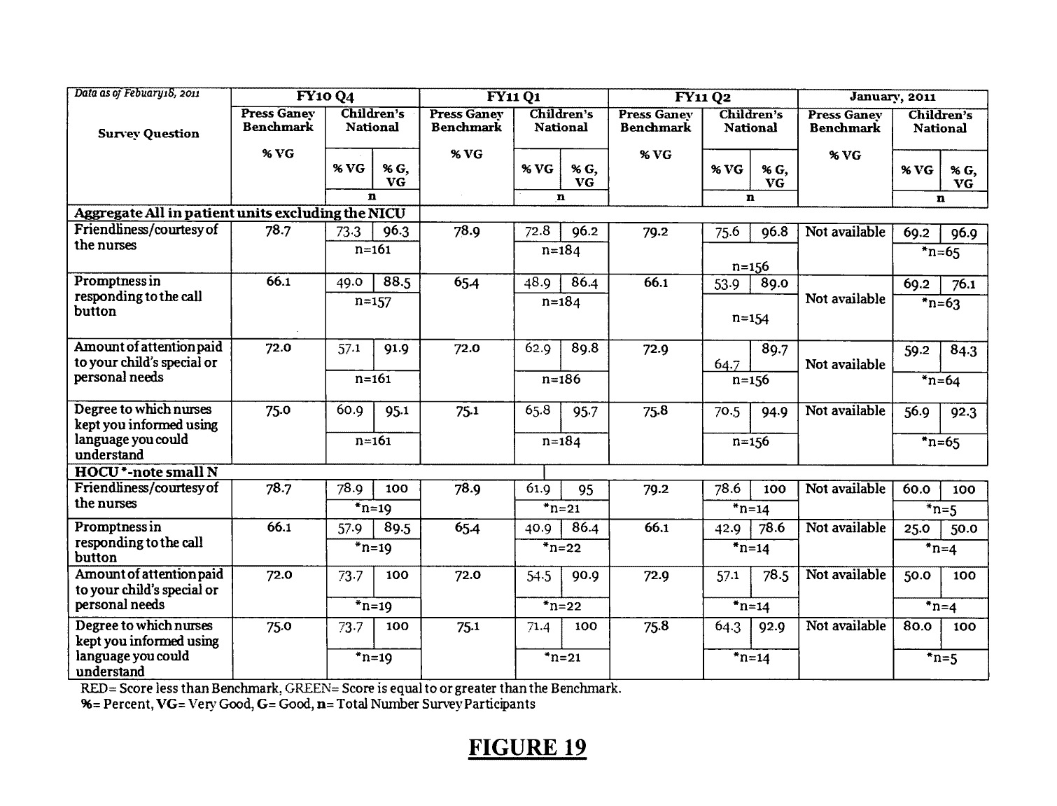

Those three steps 310-314 can be repeated by the QIK system 214 on a regular basis so as to create a call loop 316 in which the QIK system 214 mines data from the EHR system 210 and analyzes and interprets that data for specific times (e.g., weekly, monthly, quarterly, etc.) and for different groups of healthcare providers (e.g., specific staff, specific inpatient units, etc.). And, at step 318 of the QI process 318, that data can then be used to generate satisfaction reports that identify how well those healthcare providers surveyed over the designated period of time, as illustrated in FIG. 19. The satisfaction report 1900 illustrated in FIG. 19 was generated with quarterly data for all inpatient units except the ICU. Some exemplary survey questions are also illustrated in the satisfaction report of FIG. 19.

After those satisfaction reports 1900 are disseminated to the appropriate parties at step 320, they can be used at step 322 to conduct performance reviews/evaluations with the appropriate healthcare providers and to monitor the progress those healthcare providers are making toward the goals of the QI program. And the data in those reports 1900 can be compared to, and even plotted in the same graphical display with, other data that may be related to patient satisfaction, such as pain assessment compliance (e.g., FIG. 12), to allow trends in other activity to be correlated directly to patient satisfaction. Any modifications that need to be made to help better achieve the goals of the patient satisfaction QI program can then be made at step 302 of the QIK process 300, thereby initiating another iteration of the PDSA loop 324, which can be repeated until those goals are reached at step 326 of the QIK process 300. And due to their interrelation of patient satisfaction to a healthcare facility's financial performance, a similar QIK process 300 can be implemented to reach the goal of better financial performance.

As the above examples illustrate, the apparatus and method of the present invention are suitable for a wide variety of QI programs beyond just pain management (e.g., clinical efficiency, clinical effectiveness, patient satisfaction, evidence-based medicine, quality care delivery, and safe care delivery). And due to the vast amount of clinical data that is accessible via EHR systems 210, those QI programs can be as narrowly or broadly targeted as desired. Some of the benefits of such an apparatus and method are demonstrated by a specific example of their implementation, as provided immediately below.

### C. Example of Implementation

i. Project Team

A multidisciplinary project team was created that included a pain advanced practice nurse, a chief medical information officer, clinical outcomes analysts, a clinical data specialist, and a performance improvement specialist. The investigative team collaborated with the hospital Pain Committee and system and unit level committees across the inpatient units. Based on established quality improvement guidelines for pain, clinical practice guidelines, expert opinion and regulatory requirements, key metrics in the EHR system 210 were identified: (1) pain assessment is completed at admission, (2) ongoing pain assessments are completed during a hospital course, (3) reassessment of pain is completed following an intervention for pain, and (4) reassessment of pain is completed within 2 hours following an intervention for pain.

ii. Setting

A QI program was created for a freestanding tertiary 283-bed pediatric hospital (i.e., step 302 of the QIK process 300). The hospital served 360,000 patients each year with approximately 13,047 inpatient admissions. All inpatient units across the hospital were included in the pain management directive: medical care, respiratory, short stay, surgical care, hematology-oncology, adolescent psychiatry, child psychiatry, heart and kidney, neonatal intensive care, pediatric critical care and cardiac intensive care units.

iii. Primary Data Entry into the EHR System

Organizational policies and procedures for pain assessment and management were developed and implemented prior to implementation of this initiative (i.e., step 304 of the QIK process 300). Ongoing education regarding pain assessment, including the pain policy and procedure, was incorporated in hospital and unit orientation programs. According to that policy and procedure, a pain assessment included location, type, and intensity (see, e.g., FIG. 4). Pain intensity was measured using a validated tool (see, e.g., FIGS. 8A-8G) based on a patient's clinical condition, developmental age, and preference. Pain assessment and reassessment data were entered directly by clinicians in the EHR system 210 at the point of care. All pain assessments and reassessments were documented using secure bedside fixed and portable computers (i.e., clinician workstations 204) provided in the EHR system 210. Fields to document the pain location, type, onset, duration, and observations of the patient were included. The pain documentation fields were specifically designed (i.e., step 306 of the QIK process 300) to meet the needs of children utilizing standardized pediatric pain measurement tools to assess the intensity of pain. Pain treatments were documented via a drop-down menu and could be multi-selected to include both pharmacologic and non-pharmacologic treatments (see, e.g., FIGS. 7A-7C).

iv. Pain Assessment Tools

Pain scales in the setting included a Numeric Rating Scale (NRS), the Wong-Baker FACES scale (see, e.g., FIG. 8D), the PIPP scale (see, e.g., FIG. 8E), and the FLACC scale (see, e.g., FIG. 8G), and an Individualized Numeric Rating System (INRS). Generally, children older than 7 years were assessed using the NRS. The NRS is a self-reporting tool that has been utilized in children with previously established concurrent validity of 0.61-0.90. Younger children were asked to rate their pain using the Wong-Baker FACES scale, which has a test-retest reliability of 61% and a concurrent validity of 0.67-0.73. Infants and non-verbal children were assessed using the FLACC scale. The FLACC scale has been validated for use in children between two months and seven years. A FLACC score was obtained by rating each patient's behavior in the Faces, Legs, Activity, Cry, and Consolability categories. The INRS was implemented to obtain a pain intensity rating in nonverbal children with severe cognitive impairments. That scale was adapted from the NRS and requires parents/caregivers to identify specific patient behaviors related to pain. Although the INRS has yet to be validated, it provides a means for nurses to consistently document and communicate the behaviors of non-verbal patients.

v. Regular Electronic Reports on Key Metrics

The project team created specific queries of the EHR system 210 utilizing scripted programs designed to extract accurate and reliable data into MICROSOFT EXCEL brand electronic spreadsheets (i.e., steps 310 and 312 of the QIK process 300). The programs extracted data that was previously captured by clinicians in pain fields in the electronic documents of the EHR system 210 (i.e., step 308 of the QIK process 300). The data extracted from the EHR system 210 was manually validated against the documentation in the EHR system 210. That data was then post-aggregated and analyzed with the MICROSOFT ACCESS brand graphical database tool (i.e., step 314 of the QIK process 300). That data was translated into automated pain reports (i.e., step 318 of the QIK process 300) developed with the MICROSOFT ACCESS brand graphical database tool for use in performing ongoing analysis. The reports were generated on a weekly basis to capture a sample of patients across the inpatient units. The report samples were from all patients admitted for >24 hr prior to generation of the automated pain report. All patients, male and female, ages 0->21 years were included. Monthly data was generated on 200-500 patients for admission pain assessment, 600-900 ongoing pain assessment, and 250-300 reassessments post-treatment for pain (i.e., call loop 316 of the QIK process 300).

vi. Analysis and Interpretation

The MICROSOFT ACCESS brand graphical database tool was used to create two main reports: (1) Admission Assessment Reports (see, e.g., FIG. 10A) and (2) Ongoing and Reassessment Reports (not shown). The Admission Assessment Reports contained the unit name; total number of patients; percent of patients for which a pain assessment was completed at admission including a pain scale and score; the mean time for pain admission assessment; and the minimum to maximum amount of time to complete an admission pain assessment. The data for all units was also calculated to report the hospital total scores. The Ongoing and Reassessment Reports contained the unit name; total number of patients; percent of patients with a pain assessment completed twice in 24 hours; percent of patients with a pain assessment completed once in 24 hours; percent of patients with no pain assessment in 24 h; percent of patients with a pain assessment completed at a minimum of every 12 h; total number of pain treatments; percent of patients with a pain assessment post-treatment (reassessment); minimum and maximum time to reassessment; mean time to reassessment; and percent of patients with a reassessment within 2 hours of a treatment. Following aggregation and analysis of the monthly data, interpretation of the findings with translation to graphical displays and importing data into a scorecard was completed. The graphical displays provided unit comparisons as well as trends over time for targeted measures at the hospital level and unit-specific levels.

vii. Dissemination

Initially, unit-specific data was presented to shared nursing leadership unit-based practice councils by the pain advanced practice nurse (i.e., step 320 of the QIK process 300). Staff nurse members of the council were educated on interpretation of the graphical data and unit-specific scorecards. Additionally, the hospital policy and procedure were reviewed along with the importance of assessing and reassessing pain early, evaluating effectiveness of pain interventions and monitoring for side effects of treatment that could lead to adverse events (i.e., step 322 of the QIK process 300). Pain storyboards were created and placed in each patient care unit. The storyboards included hospital and unit-specific graphical data, unit scorecards, and information related to the importance of pediatric pain management in hospitalized children. Storyboards were updated on a monthly basis. At the organizational level, the graphical data were regularly provided to multidisciplinary, hospital-wide quality and clinical committees including the Pain Committee.

viii. Improvement

Utilizing rapid cycle techniques in a PDSA framework, a bundled intervention approach was implemented that varied by unit based on the performance improvement areas identified in aggregate data (See, e.g., FIG. 5). The multidisciplinary Pain Committee utilized the data to identify strengths and opportunities for improvement, develop goals, and implement system-wide interventions for improvement. A major turning point for improvement in pain assessment and reassessment occurred by redesigning the EHR pain documentation system (i.e., step 306 of the QIK process 300). Nurses and physicians at the point-of-care, Pain Committee members, Pain Medicine physicians and nurses with specialized training in pediatric pain, known as the Comfort Team, provided input into the redesign of the pain documentation system to incorporate evidence based guidelines and integrate with workflow. Unit level action plans intermittently were created by Nursing Managers and Medical Unit Directors. In addition, a quarterly recognition program was established to recognize the Best Overall, Most Improved, and Most Sustained pain program patient care units. The units that received the recognition were provided with a unit award along with individual thank you letters for each staff members' contribution to improving the clinical performance on the unit related to pain assessment and reassessment. When steady improvement had been reached by a unit but target had not yet been achieved or sustained, data was provider to the unit managers at the level of the individual nurses. In turn, interventions at the individual level could be considered. Furthermore, individual feedback was provided to staff regarding their performance data related to pain assessment if incomplete documentation was demonstrated.

ix. Results

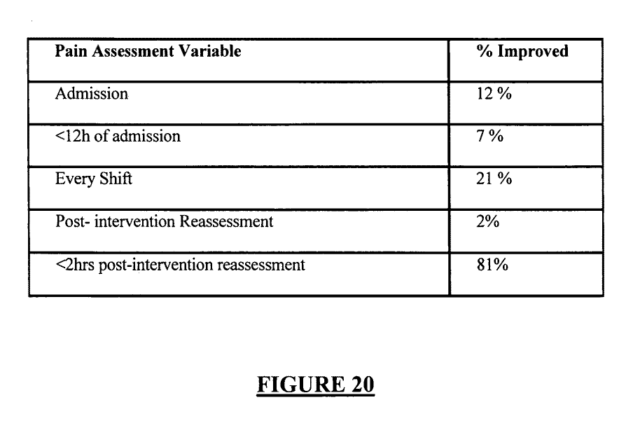

Over the course of a year-and-a-half, admission pain assessment data was gathered on 5,908 patients. From that sample, 14,882 ongoing pain assessment events and 3,362 reassessment events were extracted. From that data, improvements were demonstrated across each key metric. Greater than 90% compliance was achieved with documentation of pain assessment at admission and ongoing pain assessments (each nursing shift). Following implementation of the redesigned pain documentation flowsheet, improvements were shown in compliance greater than 90% for 3 months with the most recent 3 months just below target by 1-5%. FIG. 20 illustrates the results of that year-and-a-half QIK process 300.

### D. Summary

The present invention provides an apparatus and method for collecting, extracting, and aggregating clinical data in real time and for manipulating that data into meaningful measurements of pain assessment and management, clinical efficiency, clinical effectiveness, patient satisfaction, evidence-based medicine, quality care delivery, and safe care delivery. The present invention combines EHR functionalities with QI functionalities to improve, sustain, and advance quality, delivery, and research capabilities within healthcare. The present invention not only provides the type of quick and continuous feedback required to effectively implement QI programs in a healthcare setting, it also allows larger amounts of data to be accessed and processed, thereby providing more thorough and more accurate results. As part of such QI programs, healthcare provides can assess the effectiveness QI programs by identifying the amount compliance there is with the policies and procedures thereof, assess the effectiveness of specific interventions by identifying what care interventions result in improvements for specific patients or groups of patients as compared to other tried interventions, assess the relation of patient satisfaction to QI programs, and generate various alerts to help healthcare providers comply with the policies and procedures of QI programs. Moreover, healthcare providers can make those assessments on a more detailed level, such as at the level of individual nurse and/or at the level of individual incident, as well as at a broader level, such as across a selected period of time for different groups of patients and/or healthcare providers.

Additional advantages and modifications will readily occur to those skilled in the art. Therefore, the invention in its broader aspects is not limited to the specific details and representative embodiments shown and described, herein. Accordingly, various modifications may be made without departing from the spirit or scope of the general inventive concept as defined by the appended claims and their equivalents.

1. An apparatus for generating quality informatics knowledge comprising:
an EHR system configured to capture clinical data in electronic documents, the EHR system including an EHR database configured to store the clinical data and a clinician workstation configured to receive the clinical data as input from a healthcare provider;
a quality initiative system including a processor configured to extract a defined set of data from the EHR database based on a policy and/or procedure developed for a quality improvement program, to manipulate the defined set of data, to generate electronic reports with the manipulated data, to disseminate the electronic reports to healthcare providers, to modify the policy and/or procedure developed for the quality improvement program based on feedback from the healthcare providers, and to repeat those steps until the defined set of data identifies progress toward one or more goals of the quality improvement program.

2. (canceled)

3. The apparatus of claim 1, wherein the processor is provided as part of a quality initiative workstation that includes one or more input devices configured to receive input from a user to at least one of schedule when the processer extracts the defined set of data from the EHR database, instruct a graphical database tool how to manipulate the defined set of data, instruct the graphical database tool how to generate the electronic reports with the manipulated data, identify the healthcare providers to whom the electronic reports will be disseminated, and modify and/or create the electronic documents in the EHR system and/or fields in the electronic documents in the EHR system.

4. The apparatus of claim 3, wherein quality initiative workstation is in electronic data communication with the EHR system via a network connection.

5. A method for generating quality informatics knowledge comprising the steps of:
defining set of data to be used in implementing a policy and/or procedure developed for a quality improvement program, the quality improvement program including one or more goal;
extracting the defined set of data from an EHR system using a computing device with a processor, the defined set of data being extracted from clinical data that was captured in one or more fields of an electronic document in the EHR system;
analyzing the defined set of data using a graphical database tool;
generating electronic reports that contain the manipulated data using the graphical database tool;
disseminating the reports to different healthcare providers;
receiving feedback from the healthcare providers on the policy and/or procedure for the quality improvement program;
modifying the policy and/or procedure for the quality improvement program based on the feedback received from the healthcare providers; and
repeating the preceding steps until the defined set of data identifies progress toward the one or more goal of the quality improvement program.

6. The method of claim 5, further comprising the step of modifying and/or creating the electronic documents in the EHR system and/or the fields in the electronic documents in the EHR system as required to capture the defined set of data.

7. The method of claim 6, wherein
the step of modifying and/or creating the electronic documents in the EHR system and/or the fields in the electronic documents in the EHR system is performed after the step of receiving feedback from the healthcare providers; and
the electronic documents and/or the fields in the electronic documents are modified based on the feedback received from the healthcare providers.

8. The method of claim 5, wherein the steps of extracting the defined set of data and analyzing the defined set of data are repeated over time in a call loop that extracts defined sets of data at different times.

9. The method of claim 5, wherein the step of disseminating the reports to different healthcare providers is performed by using the processor to at least one of e-mail the reports, e-mail a link to the reports, and publish the reports to a website.

10. The method of claim 5, wherein
the step of analyzing the defined set of data includes analyzing clinical data that corresponds to at least one of a specific patient, a specific healthcare provider, a specific group of healthcare providers, and a specific healthcare facility; and
the step of generating electronic reports includes generating reports for the at least one of a specific patient, a specific healthcare provider, a specific group of healthcare providers, and a specific healthcare facility for which the clinical data was analyzed.

11. The method of claim 5, wherein the EHR system includes:
an EHR database configured to store the clinical data; and
a clinician workstation configured to receive the clinical data as input from a healthcare provider.

12. The method of claim 11, further comprising the steps of:
capturing the clinical data in the one or more fields of the electronic document in the EHR system via one or more of the healthcare providers inputting that data into the clinician workstation; and
storing the clinical data on the EHR database,
wherein the step of extracting the defined set of data includes extracting the defined set of data from the clinical data stored on the EHR database.

13. The method of claim 5, further comprising the step of scheduling a time to extract the defined set of data from the EHR system, the time corresponding to the policy and/or procedure developed for the quality improvement program.

14. The method of claim 5, wherein
the one or more goal of the quality improvement program includes improving pain assessment by at least one of a healthcare facility, a group of healthcare providers, and a specific healthcare provider;
the policy and/or procedure developed for that quality improvement program include using the EHR system to capture the defined set of data by performing pain assessments at designated times for patients;
the step of analyzing the defined set of data includes calculating a percentage of times the at least one a healthcare facility, a group of healthcare providers, and a specific healthcare provider performs a pain assessment during the designated times; and
the step of generating electronic reports includes plotting the percentage calculated by the step of analyzing with respect to a goal percentage over time.

15. The method of claim 14, wherein
the policy and/or procedure developed for the quality improvement program for improving pain assessment further includes conducting events designed to help further the goal of improving pain assessment; and
the step of generating electronic reports further includes plotting the events with respect to the percentages over time.

16. The method of claim 14, wherein
performing pain assessments includes inputting a pain score and at least one of a pain location, time of assessment, pain quality, duration of pain, pain characteristic, pain symptom, precipitating factor, and pain intervention into the EHR system using a clinician workstation at a point of care; and
the designated times are at least one of within twelve hours of an admission, within twelve hours of a previous assessment, within two hours of an intervention, and during a specific shift at a healthcare facility.

17. The method of claim 5, wherein
the one or more goal of the quality improvement program includes reducing the amount of pressure ulcers experienced by patients of at least one of a healthcare facility, a group of healthcare providers, and a specific healthcare provider;
the policy and/or procedure developed for that quality improvement program include using the EHR system to capture the defined set of data by performing pressure ulcer assessments at designated times for the patients that are susceptible to pressure ulcers;
the step of analyzing the defined set of data includes identifying triggering events based on the defined set of data, the triggering events corresponding to a situation that is likely to cause at least one of a patient to develop a pressure ulcer and an existing pressure ulcer to worsen; and
the step of generating electronic reports includes generating alerts that identify the situations to which the triggering events correspond.

18. The method of claim 17, wherein
performing pressure ulcer assessments includes inputting at least one of a risk a patient will develop a pressure ulcer, whether the patient is being restrained in any way, a preventative intervention in place, a number of existing pressure ulcers observed, a location of existing pressure ulcers, and a stage of existing pressure ulcers into the EHR system using a clinician workstation at a point of care; and
the step of disseminating the reports to different healthcare providers includes sending the alerts to the healthcare providers via at least one of a clinician workstation, a pager, a cellular telephone, and a smart phone.

19. The method of claim 5, wherein
the one or more goal of the quality improvement program includes improving adverse event detection by at least one of a healthcare facility, a group of healthcare providers, and a specific healthcare provider;
the defined set of data includes at least one of medications, laboratory values, and admit/discharge/transfer events that have the potential to cause adverse events;
the step of analyzing the defined set of data includes identifying a potential adverse event for one or more patients based on an amount of medication administered over time, a type of medication administered with or without another type of medication, a change in laboratory values over time, and a number of admit/discharge/transfer events occurring over time; and
the step of generating electronic reports includes generating alerts that identify the potential adverse event and a reason for that potential adverse event, the reason being at least one of the amount of medication administered over time, the type of medication administered with or without another type of medication, the change in laboratory values over time, and the number of admit/discharge/transfer events occurring over time.

20. The method of claim 19, wherein the step of disseminating the reports to different healthcare providers includes sending the alerts to the healthcare providers via at least one of a clinician workstation, a pager, a cellular telephone, and a smart phone.

21. The method of claim 19, wherein the step of generating electronic reports further includes plotting a total number of patient transfers to an Intensive Care Unit from other units at a healthcare facility on a unit-by-unit basis for a specified period of time.

22. The method of claim 5, wherein
the one or more goal of the quality improvement program includes improving customer satisfaction within at least one of a healthcare facility and a group of healthcare providers;
the policy and/or procedure developed for that quality improvement program include using the EHR system to capture the defined set of data as patient satisfaction data obtained from patients during inpatient stays;
the step of analyzing the defined set of data includes calculating a percentage of the patients that indicated a certain level of satisfaction in the patient satisfaction data; and
the step of generating electronic reports includes listing a series of categories for which patient satisfaction data was captured along with the percentage of the corresponding level of satisfaction for each of those categories.

23. The method of claim 22, wherein using the EHR system to capture patient satisfaction data includes using a customer satisfaction system that is integrated with the EHR system to receive the patient satisfaction data as input from patients via one or more computing devices placed in the patients' rooms.

24. The method of claim 5, wherein
the one or more goal of the quality improvement program includes improving customer satisfaction within at least one of a healthcare facility and a group of healthcare providers;
the policy and/or procedure developed for that quality improvement program include using the EHR system to capture the defined set of data by performing pain assessments at designated times for patients and obtaining patient satisfaction data from those patients during inpatient stays;
the step of analyzing the defined set of data includes:
calculating a first percentage, the first percentage being calculated as a percentage of times at least one of a healthcare facility, a group of healthcare providers, and a specific healthcare provider performed the pain assessments during the designated times, and
calculating a second percentage, the second percentage being calculated as a percentage of the patients that indicated a certain level of satisfaction in the patient satisfaction data; and
the step of generating electronic reports includes plotting the first percentage and the second percentage with respect to each other over a specified period of time.

25. The method of claim 24, wherein
the policy and/or procedure developed for the quality improvement program for improving customer satisfaction further includes conducting events designed to help further the goal of improving customer satisfaction; and
the step of generating electronic reports further includes plotting the events with respect to the first and second percentages over time.
